(19) United States
(12) Patent Application Publication
(10) Pub. No.: US 2012/0116868 A1
(43) Pub. Date: May 10, 2012

(54) SYSTEM AND METHOD FOR OPTIMIZING MARKETING EFFECTIVENESS

(76) Inventors: Wendy Tsyr-Wen Chin, New York, NY (US); Andrew Michael Heard, Chatham, NJ (US); Paul Richard Hager, Baltimore, MD (US); Donald Lloyd Roth, West Palm Beach, FL (US)

(21) Appl. No.: 13/286,348

(22) Filed: Nov. 1, 2011

Related U.S. Application Data
(60) Provisional application No. 61/412,354, filed on Nov. 10, 2010.

(51) Int. Cl. G06Q 30/02

(52) U.S. Cl. 705/14.43; 705/14.41

(57) ABSTRACT

The claimed invention relates to a system and computer implemented method for quantitatively measuring effectiveness of a marketing campaign or marketing strategy execution. The client device accesses the server over a communications network to define targeted customer segments based on the marketing campaign or a specific set of marketing objectives and to define a quantifiable outcome or payoff for each targeted customer segment of the client, thereby linking the performance of client's marketing campaign or objectives to the quantifiable outcome for each targeted customer segment. The server generates behavior paths for each targeted customer segment on a client website for effective measurement of adherence of a website visitor/customer to the behavior paths leading to the quantifiable outcome. The rules engine calculates a path score to determine whether the customer adheres to or diverges from a preferred behavior path established for the customer's targeted customer segment.

### RELATED APPLICATION

This application claims the benefit of U.S. Provisional Application No. 61/412,354 filed on Nov. 10, 2010, which is incorporated herein by reference in its entirety.

### BACKGROUND OF THE INVENTION

The claimed invention is directed to providing a solution for shaping customer's on line behavior. Every successful marketing or communications campaign has a clear purpose. The campaign should convey a compelling message of “call to action” that should direct the target audience down a preferred action path, much like catalysts eliciting desired behavior. A marketing campaign's set of intended outcomes will vary greatly. Its purpose may be product education, brand refresh, customer intelligence, or sales transactions. Accurate measurement of the campaign's success is fundamental to maximizing benefit from marketing investment. Yet, many marketing programs fall short in meeting their objectives. Market campaign analyses offer little assurance that marketing investment actually translate into expected business outcomes. All too often, measurement of campaign success draws only a correlation between advertizing and results. There is no insight as to how the marketing campaign affected audience behavior—or if it did at all. That is, there is no understanding as where and why the intended audience may have deviated from a preferred “behavioral” path.

According to a Forrester research report, marketers continue to shift dollars away from traditional media toward integrated marketing communications (“IMC”) strategies that try to converge search marketing, display advertising, email marketing, social media, and mobile marketing. The key question a marketer should ask within the IMC framework ‘is my website working the way I want it to’ as the new media (search marketing, display advertising, social media etc.) converges on one's website—the focal point of an IMC. However, most companies view website traffic and time spent on their websites as the most important measurements of website success, that is, the higher the traffic and the more time a visitor spends on the website the better. Thus, a marketing campaign that results in large web traffic and causes individual visitors to spend a lot of time on the site is considered successful, but does the website really perform as the marketer envisioned it to?

Contrary to conventional wisdom, research has shown that quite often a visitor's time spent on a website is inversely correlated to her satisfaction with the site. Furthermore as marketing messages increasingly target specific demographics, one would logically expect that there would be extension of these focused messages to the website, such as creating individual paths for the targeted segments to ensure that the marketer can proactively shape her on-line visitors' behavior.

Existing data models and analytic products provide after-action analyses. Such analysis cannot always delineate the different types of interactions that occur between customers and the intended product/message. For example, a marketer may measure the effectiveness of product campaign by looking at the sales result, but the analysis is unable to interpret the relationship between the product and the consumer. Can the analysis recognize the visitor as an impulse shopper or a long-term converter? Can an analytic tool clearly identify which part of the campaign is more effective in driving the preferred behavior (e.g., sales) so that investment dollars can be allocated for greatest return? For organizations with fulfillment centers dependent on website exchange (not via brick and mortar), would the marketing framework be able to shape visitors' behavior on their website and thus achieve desired campaign outcome? For most organizations, the answer to these questions is most likely, NO. The bottom line is that today's analytic tools generally measure the marketing success through correlative inference. They provide little insight as to cause-and-effect return on a specific component investment within a marketing campaign. Thus they do not help the website owner or operator in affecting customer behavior, and cannot provide any insight or recommendation as to where and how the website owner/operator can improve its marketing program.

A typical question “does my website function the way I want it to” should be followed by the question “what do I want my website to do” which leads to designing the website with the capability to measure a marketer's call to action—execution of her marketing strategy!

The claimed iPath system enables companies to measure the effectiveness of how integrated marketing programs are executed by designing preferred customer behavioral paths on their websites based on pre-defined customer segmentations. The iPath system implemented on a website is similar to planning product placements and floor layout in a physical store. One would place snacks next to soda to entice bundled purchases, so why wouldn't one apply the same concept to the virtual store? Once implemented, the result is a consumer-facing website that seamlessly guides visitors down their preferred path to payoff. The iPath system also allows automatic measurement of customer adherence or deviation from the desired paths; and a marketing program's ability to affect customer behaviors on-line. The iPath system enables the client to develop a highly-focused marketing campaign with direct and quantifiable outcomes, to include verifiable improvement in marketing ROI.

### OBJECT AND SUMMARY OF THE INVENTION

Therefore, it is an object of the claimed invention to provide a system and method that solves the aforesaid problems.

In accordance with an exemplary embodiment of the claimed invention, a computer implemented method for quantitatively measuring effectiveness of a marketing campaign or marketing strategy execution comprises the step of accessing a processor based server over a communications network to define targeted customer segments based on the marketing campaign or a specific set of marketing objectives by a client using a client device. A quantifiable outcome or payoff for each targeted customer segment of the client on the server is defined by invoking one or more component tools of the server by the client device over the communications network, thereby linking the performance of client's marketing campaign or objectives to the quantifiable outcome for each targeted customer segment. The behavior paths for each targeted customer segment on a client website is generated by the client using the server for effective measurement of adherence of a website visitor/customer to the behavior paths associated with the visitor/customer's targeted customer segment leading to the quantifiable outcome. A weight to each step of each behavior path for each targeted customer segment is assigned by the client using one or more component tools of the server. The rules engine categorizes the customer visiting the client website into one of the targeted customer segments based on segmentation rules and determines a customer path traversed on the client website. The rules engine calculates a path score in accordance with the rules associated with the targeted customer segments established by the client and the weight assigned to each step of the customer path to determine whether the customer adheres to or diverges from a preferred behavior path established for the customer's targeted customer segment. The database stores the path score and the customer path.

In accordance with an exemplary embodiment of the claimed invention, the aforesaid method analyzes the client website to import sitemaps and to imbed tags to various pages of the client website to facilitate data collection and analysis by the server.

In accordance with an exemplary embodiment of the claimed invention, the aforesaid method determines whether the customer was correctly placed into the targeted customer segment based on the segmentation rules established by the client and imposed by the rules engine of the server.

In accordance with an exemplary embodiment of the claimed invention, the aforesaid method categorizes the customer by the rules engine based on at least one of the following segmentation rules: a first webpage of the client website accessed by the customer or a landing page rule and a website visited by the customer before accessing the client website or a referral website rule.

In accordance with an exemplary embodiment of the claimed invention, the rules engine is a self-learning rules engine that adds, deletes or modifies the segmentation rules to correctly place a misplaced customer into a correct targeted customer segment. The database stores the added or modified segmentation rules.

In accordance with an exemplary embodiment of the claimed invention, the aforesaid method assigns a priority rank to each segmentation rule to prioritize the segmentation rules.

In accordance with an exemplary embodiment of the claimed invention, the aforesaid method filters web data to exclude immaterial visits to client website.

In accordance with an exemplary embodiment of the claimed invention, the aforesaid method generates the preferred behavior path for each targeted customer segment to shape customer interactions on the client website and guides the customer to the preferred behavior path, thereby maximizing the quantifiable outcome consistent with the client's marketing campaign or objectives.

In accordance with an exemplary embodiment of the claimed invention, the aforesaid method simulates changes to the client websites using a simulation engine of the server to determine its effectiveness before actually deploying the changes to the client website.

In accordance with an exemplary embodiment of the claimed invention, the aforesaid method generates a standard or custom data visualization report based on a data range selected by the user.

In accordance with an exemplary embodiment of the claimed invention, the claimed system for quantitatively measuring effectiveness of a marketing campaign or marketing strategy execution comprises a processor based server comprising rules engine and one or more component tools. The client device accesses the server over a communications network to define targeted customer segments based on the marketing campaign or a specific set of marketing objectives and to define a quantifiable outcome or payoff for each targeted customer segment of the client, thereby linking the performance of client's marketing campaign or objectives to the quantifiable outcome for each targeted customer segment. The server generates behavior paths for each targeted customer segment on a client website for effective measurement of adherence of a website visitor/customer to the behavior paths associated with the visitor/customer's targeted customer segment leading to the quantifiable outcome. The server assigns a weight to each step of each behavior path for each targeted customer segment based on a client input. The rules engine categorizes the visitor/customer visiting the client website into one of the targeted customer segments based on segmentation rules and determines a customer path traversed on the client website. The rules engine calculates a path score in accordance with rules associated with the targeted customer segment established by the client and the weight assigned to each step of the customer path to determine whether the customer adheres to or diverges from a preferred behavior path established for the customer's targeted customer segment. A database stores the path score and the customer path.

In accordance with an exemplary embodiment of the claimed invention, the one or more component tools of the server analyzes the client website to import sitemaps and imbed tags to various pages of the client website to facilitate data collection and analysis by the server.

In accordance with an exemplary embodiment of the claimed invention, the aforesaid rules engine of the server determines whether the customer was correctly placed into the targeted customer segment based on the segmentation rules established by the client.

In accordance with an exemplary embodiment of the claimed invention, the aforesaid rules engine categorizes the customer based on at least one of the following segmentation rules: a first webpage of the client website accessed by the customer or a landing page rule and a website visited by the customer before accessing the client website or a referral website rule.

In accordance with an exemplary embodiment of the claimed invention, the aforesaid rules engine is a self-learning rules engine, and adds, deletes and modifies the segmentation rules to correctly place misplaced customers into a correct targeted customer segment in the future. The database stores the added or modified segmentation rules.

In accordance with an exemplary embodiment of the claimed invention, the aforesaid segmentation rules are ranked or prioritized based on a client input. The aforesaid rules engine favors the segmentation rules with a higher rank or priority.

In accordance with an exemplary embodiment of the claimed invention, the aforesaid server generates the preferred behavior path for each targeted customer segment to shape customer interactions on the client website and guides the customer to the preferred behavior path, thereby maximizing the quantifiable outcome consistent with the client's marketing campaign or objectives.

In accordance with an exemplary embodiment of the claimed invention, the aforesaid server further comprises a simulation engine to simulate changes to the client websites to determine its effectiveness before actually deploying the changes to the client website.

In accordance with an exemplary embodiment of the claimed invention, a non-transitory computer readable medium comprises computer executable code for quantitatively measuring effectiveness of a marketing campaign or marketing strategy execution. The computer executable code comprises instructions for accessing a processor based server over a communications network to define targeted customer segments based on the marketing campaign or a specific set of marketing objectives by a client using a client device; defining a quantifiable outcome or payoff for each targeted customer segment of the client on the server by invoking one or more component tools of the server by the client device over the communications network, thereby linking the performance of client's marketing campaign or objectives to said quantifiable outcome for each targeted customer segment. The code comprises instructions for generating behavior paths for each targeted customer segment on a client website using the server for effective measurement of adherence of a website visitor/customer to the behavior paths associated with said visitor/customer's targeted customer segment leading to the quantifiable outcome. Additionally, the code comprises instructions for assigning a weight to each step of each behavior path for each targeted customer segment by the client using one or more component tools of the server; categorizing the customer visiting the client website into one of the targeted customer segments by a rules engine of the server based on segmentation rules; and determining a customer path traversed on the client website. The code further comprises instructions for calculating a path score by the rules engine of the server in accordance with rules associated with the targeted customer segments established by the client and the weight assigned to each step of the customer path to determine whether the customer adheres to or diverges from a preferred behavior path established for the customer's targeted customer segment; and storing the path score and the customer path in a database.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the specific concepts and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The following detailed description, given by way of example, and not intended to limit the present invention solely thereto, will best be understood in conjunction with the accompanying drawings in which like components or features in the various figures are represented by like reference numbers:

FIG. 1 is an exemplary schematic diagram of a network incorporating the iPath system in accordance with an exemplary embodiment of the claimed invention;

FIG. 2 is an exemplary schematic diagram of the iPath system in accordance with an exemplary embodiment of the claimed invention;

FIG. 3 is an exemplary diagram of various components of the iPath user interface accessible by the iPath user in accordance with an exemplary embodiment of the claimed invention;

FIG. 4 is an exemplary screenshot of the create iPath component of the iPath user interface in accordance with an exemplary embodiment of the claimed invention;

FIG. 5 is an exemplary screenshot of the display/edit iPath component of the iPath user interface in accordance with an exemplary embodiment of the claimed invention;

FIG. 6 is an exemplary screenshot of the input/edit/display simulation assumptions component of the iPath user interface in accordance with an exemplary embodiment of the claimed invention;

FIG. 7 is an exemplary diagram of various components of the iPath website interface accessible by the iPath user in accordance with an exemplary embodiment of the claimed invention;

FIG. 8 is an exemplary phase diagram of iPath methodology in accordance with an exemplary embodiment of the claimed invention;

FIG. 9 is an illustrative data architecture of deploying iPath components within existing client infrastructure in accordance with an exemplary embodiment of the claimed invention;

FIG. 10 is an schematic diagram of campaign hierarchy in accordance with an exemplary embodiment of the claimed invention;

FIG. 11 is an exemplary schematic diagram of computing an iPath score in accordance with an exemplary embodiment of the claimed invention;

FIG. 12 is an exemplary diagram of the iPath engine in accordance with an exemplary embodiment of the claimed invention;

FIG. 13 is an exemplary graph of autonomic segmentation in accordance with an exemplary embodiment of the claimed invention;

FIG. 14 is an exemplary schematic diagram of an iPath simulation engine in accordance with an exemplary embodiment of the claimed invention;

FIG. 15 is an exemplary schematic diagram of using historical data to compute the traffic flow between each steps within the individual iPath in accordance an exemplary embodiment of the claimed invention;

FIG. 16 is an exemplary data model in accordance with an exemplary embodiment of the claimed invention;

FIG. 16A is an exemplary simplified application architecture of the iPath system incorporating the mobile iPath component in accordance with an exemplary embodiment of the claimed invention; and

FIG. 17 is an exemplary data flow diagram in accordance with an exemplary embodiment of the claimed invention.

### DESCRIPTION OF THE EMBODIMENTS

A typical question “does my website function the way I want it to” should be followed by the question “what do I want my website to do” which leads to designing the website with the capability to measure a marketer's call to action—execution of her marketing strategy! The iPath system enables companies to measure the effectiveness of how integrated marketing programs are executed by designing preferred customer behavioral paths on their websites based on pre-defined customer segmentations. The iPath system implemented on a website is similar to planning product placements and floor layout in a physical store. One would place snacks next to soda to entice bundled purchases, so why wouldn't one apply the same concept to the virtual store? Once implemented, the result is a consumer-facing website that seamlessly guides visitors down their preferred path to payoff. The iPath system also allows automatic measurement of customer adherence or deviation from the desired paths; and a marketing program's ability to affect customer behaviors on-line. The iPath system enables the client to develop a highly-focused marketing campaign with direct and quantifiable outcomes, to include verifiable improvement in marketing ROI.

Every customer interaction represents, in part or whole, a journey resulting in an ideal outcome that satisfies a need and strengthens the relationship (e.g., results in a sale, delivers some positive experience, enables customer advocacy). In accordance with an exemplary embodiment of the claimed invention, iPath™ system (a trademark owned by the assignee of this application) is a product suite (e.g., mobile iPath and web based iPath systems) that offers a complete solution to clients, e.g., organizations, corporations, e-retailer, etc., marketing to the Internet enabled world from start to finish. The iPath system starts with creating individual path per targeted customer segments on-line to shape visitor behaviors to extending the paths to mobile devices, such as smart-phones or smart-devices. The iPath system was developed with “design for measurability” as a foundation. The iPath system enables the clients to measure each integrated marketing communications' (“IMC”) ability to elicit the types of end results most important to the client and its customers. The following are some exemplary terms and concepts helpful in understanding the claimed invention:
a. An “iPath score” is a quantified measure of a website's ability to lead a customer visit to a payoff
b. “Design for Measurability” is the consideration of the unobtrusive measurability of value (payoff) infused within the design of the program and which yields meaningful metrics of program activity.
c. “Payoff” is a term for a desired outcome of any interaction. Payoff is relative—meaning a payoff for one transaction may be an undesirable outcome for another.
d. “Path to payoff” (path or behavioral path) is the experiential sequence of steps or activities of an interaction, inclusive of any call to action that leads to a payoff One of the virtues of adopting the iPath methodology is the invaluable insight gained by understanding where and why a customer might stray from the desired path.
e. Every customer interaction has value, positive or negative.

As communication technology advances, global ecommerce and societal communication melded via multi-media devices. In this mixing of physical and virtual, an effective marketing campaign must present a consistent message—and tailor its look & feel to fit the specific media, customer, and situation. The e-media platform becomes a window for product marketing and customer communication. A typical marketing campaign might employ traditional media, such as TV commercials, print ads, bill boards, or even social networking sites to draw traffic to the campaign's focal point—the website. The ability to differentiate the performance of each component of the marketing campaign, and to shape visitor behavior during website visits is critical. The claimed invention enables clients and iPath users to achieve this goal, one that is overlooked or unmet by traditional marketing frameworks.

Unlike web analytic companies that focus on the macro analysis of overall website data, the claimed iPath analytical system leverages data mining, data modeling, and regression analysis to articulate marketing goals and design preferred behavioral paths for web visitors. The key objectives are to a) link campaign components' performance to a quantifiable outcome (payoff), and b) define targeted customer segmentations and the optimal customer behavior for each of the segments, respective of campaign goals. Using inference, navigation, self-identification, and other scoring parameters, the iPath system assign each visitor into a market segment, and determine a likely source from whence they came (e.g. click-through, banner ads, other websites, or general mass media). Understanding source and segment, the iPath system assesses each visitor's adherence to a path. In the event a statistically significant number of visitors diverge from a path, the iPath system gives a marketer the ability to go deeper to understand causality and formulate improvements to minimize loss-yield ratio. Common causes of divergence are difficult site navigation and ineffective behavioral path design (i.e. the yellow brick road took Dorothy to the poppy field instead of Oz).

As a result, the iPath system can quantitatively measure where and provide insight to why customers diverge from the path, and use the knowledge to continually refine, optimize, and improve the website iPath score and marketing strategies. The result is greater visitor adherence to preferred paths and attainment of desired outcomes.

That is, the iPath system can help clients to create a more effective marketing communications program by: a) linking campaign component performance to actual payoffs, thus allowing optimal allocation of marketing investment across different media to achieve a better return on investment (“ROI”); b) shaping the customers' behavior on the client website, guiding them on the preferred paths and thus, fostering an intimate relationship with the customers; and c) validating customer and market segment assumptions to ensure marketing goals and priorities are consistent across different media.

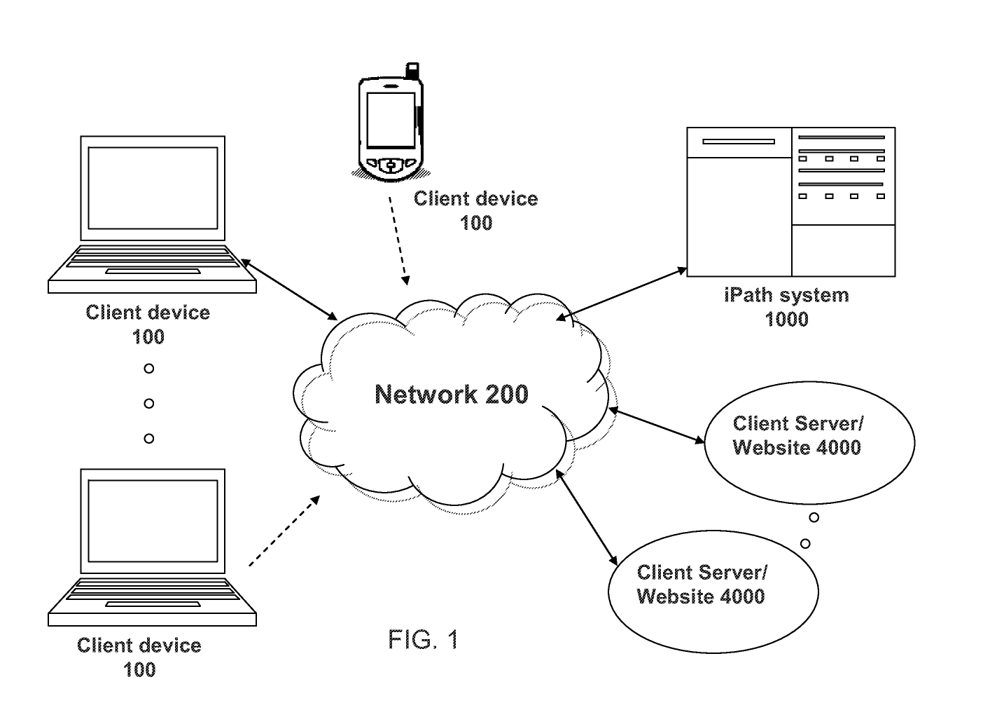

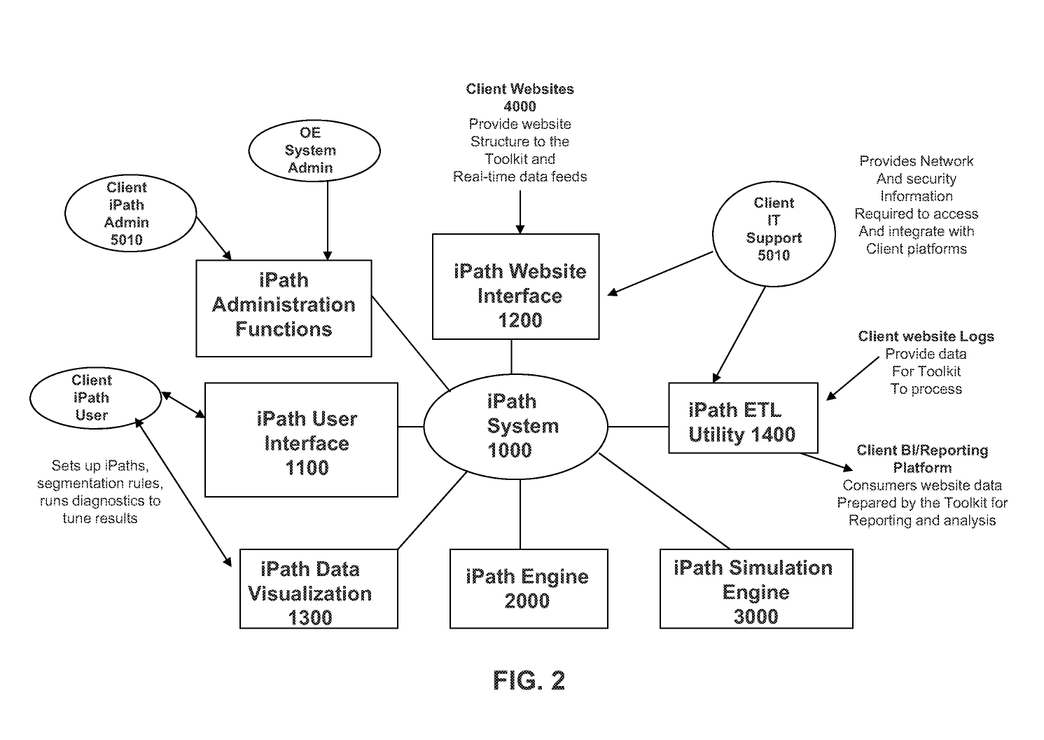

Turning now to FIGS. 1 and 2, the iPath system 1000 comprises application programs residing in a server and databases that interact with client websites, users and systems. The iPath system 1000 comprises iPath user interface 1100, iPath website interface 1200, iPath data visualization tool 1300, iPath engine 2000, and iPath simulation engine 3000. The iPath system 1000 is connected to a plurality of client devices 100 and a plurality of client servers/websites 4000 over a communications network 200.

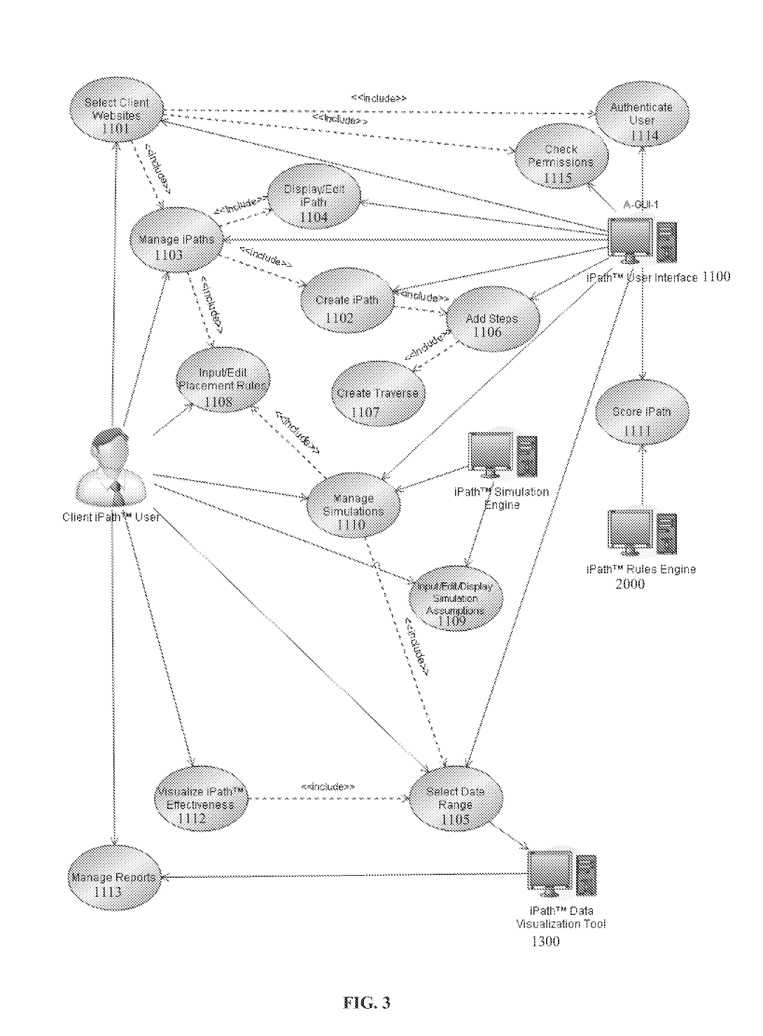

In accordance with an exemplary embodiment of the claimed invention, iPath users or clients (using a user or client device 100) interact with the components of the iPath system 1000 from a single graphical user interface or iPath user interface 1100 to create, score, remediate, and simulate iPaths. The iPath is the fundamental unit of iPath Design for Measurability. It is appreciated that an iPath user or client, or iPath user or client device 100 are used interchangeably herein since the iPath clients/users accesses the iPath system 1000 through the user/client devices 100. Customers traverse steps in a path within the context of a market segment defined by criteria used to distinguish one path from another. Typically these criteria are distinct elements such as referral sites, search words, landing pages etc. and/or payoffs. Furthermore, a defined segment can have only one path, thus, there is a 1 to 1 relationship between a defined customer segment and an iPath. FIG. 3 illustrates exemplary components of the iPath system 1000 that the iPath user can access and utilize through the iPath user interface 1100, such as a select client websites component 1101, a create iPath component 1102, a manage iPaths component 1103, a display/edit iPath component 1104, a select date range component 1105, an add steps component 1106, a create traverse component 1107, an input/edit placement rules component 1108, an input/edit/display simulation assumptions component 1109, a mange simulations component 1110, a score iPath component 1111, a visualize iPath effectiveness component 1112, a manage reports component 1113, an authenticate user component 1114, and a check permissions component 1115.

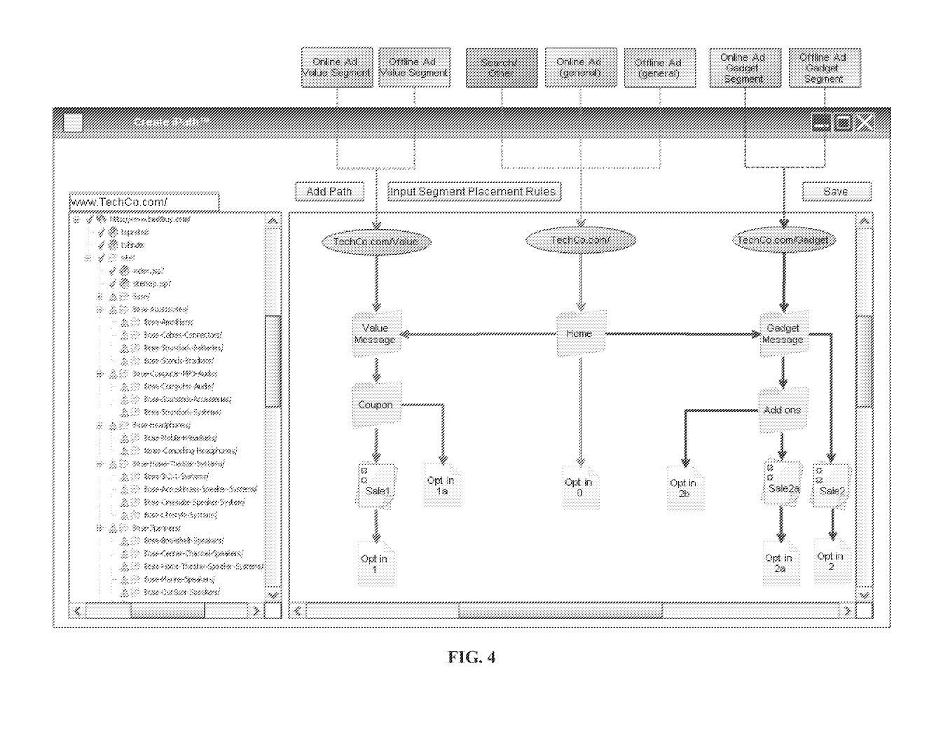

In accordance with an exemplary embodiment of the claimed invention, as shown in FIG. 4, the iPath user can use the iPath user interface 1100 to access the create iPath component 1102 from the iPath system 1000 to create iPaths by selecting steps and to access the create traverse component 1107 to create the traverses between the steps from a sitemap of the client website 4000 that also allows them to browse content. Once the iPath is defined, the iPath user can also assign payoff weighting and create the business rules for defining what segment/iPath a customer should be assigned to. The iPath user can input values and/or thresholds for key attributes identified for segment definition. The iPath user can access the input/edit placement rules component 1108 to define a set of business rules that uses these attribute/value pairs to create prioritized business rules that will be processed by the iPath engine 2000.

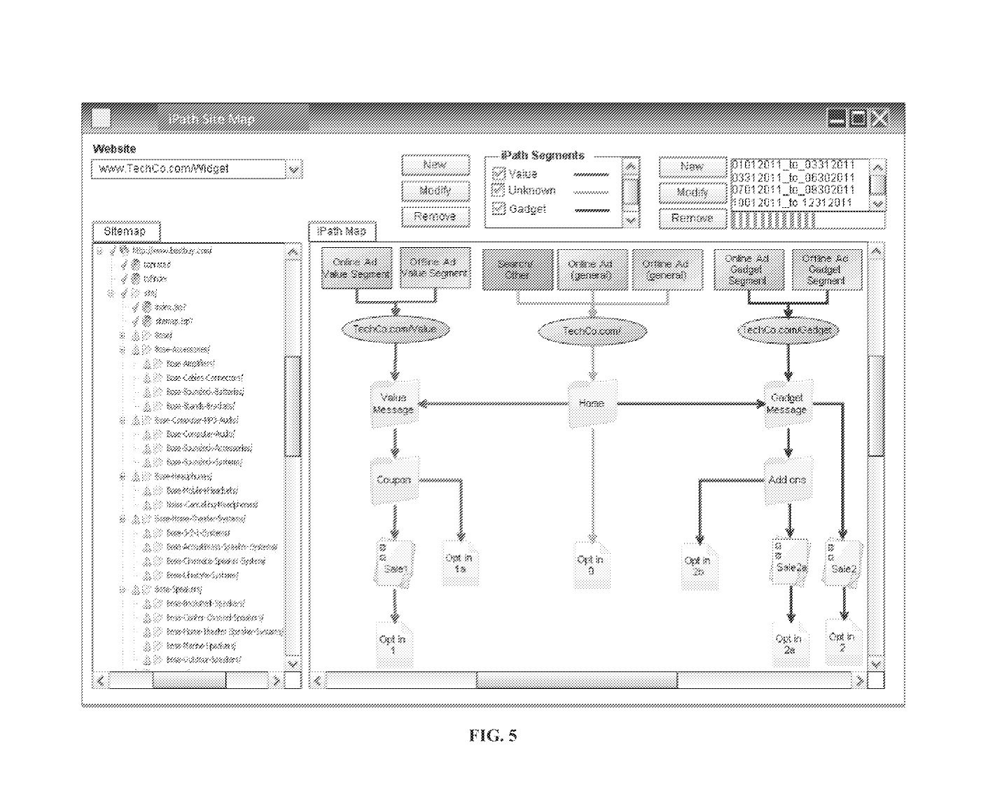

The create iPath component 1102 is invoked by the user to create the iPath, as shown in FIG. 4, and the display/edit iPath component 1104 is invoked by the user to display, modify and remove existing iPaths, as shown in FIG. 5. Where there is an existing client website 4000, users can drag and drop web pages, frames, and other types of content into each path step using a graphical interface with the create iPath component 1102, the manage iPaths component 1103 and the display/edit iPath component 1104. Whether or not there is an existing site, the iPath system 1000 provides the necessary components and/or tools to enable a user to specify the steps by manually creating the graphical icons and specifying the associated criteria.

Once authenticated by the iPath system 1000, the iPath user can perform the following exemplary tasks using one or more available components/tools accessible from the iPath user interface 1100: manage websites 4000 within his/her control with the select client websites component 1101; create/edit/delete iPaths with the create iPath component 1102, the manage iPaths component 1103 or display/edit iPath component 1104; create/edit/delete steps with the add steps component 1106; create/edit/delete traverse with the create traverse component 1107; input/edit/display iPath placement rules with the input/edit placement rules component 1108; input assumptions for simulation purposes with the input/edit/display simulation assumptions component 1109; run simulation with the manage simulations component 1110; and manage data visualization reports with the manage reports component 1113.

When the user accesses the select client websites component 1101 using the iPath user interface 1100, the select client websites component 1101 presents a list of websites 4000 that the user is authorized to access. That is, when an iPath user logs into the iPath system 1000, the user is presented with the list of authorized websites 4000 that she has access to. The user can invoke the manage iPaths component 1103 to add, modify or remove iPaths associated with a website 4000 selected using the select client websites component 1101. If the user is an administrator, then the iPath user interface 1100 also presents the administration functions available to the user as an administrator.

In accordance with an exemplary embodiment of the claimed invention, the create iPath component 1102 allows the user to create an iPath using a graphical interface and a sitemap to identify the steps. Preferably, the create iPath component 1102 enables the iPath users to specify and draw iPaths graphically. When a user selects the create iPath component 1102 from the iPath user interface 1100 to create an iPath, the create iPath component 1102 presents the user with a “blank slate” that can be populated by dragging and dropping page(s) or tags onto user's computer screen. Based on this action by the user, the create iPath component 1102 creates a “step” for a new or existing path. A step can contain multiple relevant pages, or can just contain one single page. Pages can be reused in different steps and/or different path creations. An iPath must start with a source step and end with a payoff step. A source could be a referral site, an IP address, banner ads etc., and a payoff can be a page that represents an engagement with the visitor such as opt-in to receive news letter, or a purchase. The movement from one step to another is a traverse. The user will connect the “from” step and the “to” step with a traverse. The iPath system 1000 enables the user to add or remove steps and/or add or remove traverses to create a satisfactory iPath using the various components accessible from the iPath user interface 1100. Additionally, the iPath system 1000 enables user to select a step or steps and assign them as payoff steps, and provide a weighting for each of the payoffs. It is to be noted, an iPath may have multiple payoffs representing multiple points where a visitor can be engaged within the client website 4000. Once the iPath has been created, the score iPath component 1111 can be used to calculate the iPath score by selecting a set of data (based on date range) to perform the calculation. The manage reports component 1113 presents a data visualization report to the user with the iPath score based on the selected data.

As exemplary shown in FIG. 5, the display/edit iPath component 1104 presents a graphical view of the iPath of the website 4000 selected by the user with the select client websites component 1101. That is, the display/edit iPath component 1104 presents the user with the graphical display of the iPath created based on the selected website 4000 on the user's or client's device 100, such as a computer, laptop, tablet, smart phone, portable mobile device and the like. In accordance with an exemplary embodiment of the claimed invention, the display/edit iPath component 1104 provides the user with the option of modify the iPath, removing the iPath or selecting a range of data based on dates to review with the data visualization tool 1300. The user also has the option, based on the selected data, to forecast results using simulation engine 3000. The user can add or remove steps by invoking the add steps component 1106 and add or remove traverses by invoking the create traverse component 1107 using the sitemap displayed on the user's device 100.

The select date range component 1105 takes user input to create a date range to apply to the iPath for data visualization by the data visualization tool 1300, a report by the manage reports component 1113, or a simulation by the iPath simulation engine 3000. That is, the select data range component 1105 is invoked by the iPath user to select a set of data, based on from and to dates, to provide to the data visualization tool 1300 for running the data visualization reports and/or to the iPath simulation engine 300 for running a simulation. Further, the data visualization tool 1300 can be used by the iPath user to perform drill down of data. The select date range component 1105 validates the selected date range for the website 4000 and available transaction data.

The iPath user invokes the add steps component 1106 to add a step to an existing or new iPath. The add steps component 1106 presents user with a list of steps created and allows users to choose a starting or end point step for the iPath created or being created. Each iPath must have a starting and end point (step) and when the iPath user selects the start and end points, the add steps component updates the graphical display of the iPath. A step can be a payoff. If the step is a payoff step, then the add steps component 1106 will ask user to assign weighting to the step. The graphical display is updated once the process is completed and the database 5000 is updated with the iPath metadata.

The iPath user can invoke the create traverse component 1107 to add a traverse to the iPath, thus forming a directional flow from one step 1 to another step. A traverse is created by the iPath user selecting a “from” and “to” step and joining them together using the create traverse component 1107. Preferably, the create traverse component 1107 provides graphical interface for the iPath user to perform this process graphically, by dragging and dropping a connector.

The input/edit placement rules component 1108 displays a screen to allow user to select variables and create rules for segment assignment. Each iPath needs to be associated (or assigned) to a specific segment based on rules provided by the iPath user or client. For the selected website 4000, the input/edit placement rules component 1108 displays the current rules used to place a customer visit to the client's website 4000 to a segment. The iPath user or client can invoke the input/edit placement rules component 1108 to select a rule to modify or remove, or to add a new rule. The input/edit placement rules component 1108 provides variables that can be selected by the iPath user to create the rule which is a set of conditions for a visit, if met, the iPath system 1000 assigns the customer visitor's visit to the client's website 4000 to a specified segment.

In accordance with an exemplary embodiment of the claimed invention, the input/edit placement rules component 1108 assigns a priority rank to the rules, thereby enabling the iPath system 1000 to place the customer visitor into a specific iPath when multiple rules are satisfied. For example, the “Gadget Lover” path may have the following rules associated with it to ensure visitors to the website 4000 are placed properly in the “Gadget Lover” segment versus the “Value Shopper” segment. If a visitor came from a referring website identified for the “Gadget Lover” segment, then landed on the “Gadget Lover” message page, and then viewed the featured product page for the “Gadget Lover,” then the iPath engine 2000 will place that customer visitor in the “Gadget Lover” segment. However, if a visitor came from one of the referral sites identified for “Gadget Lovers” but went to the “Value Shopper” message page and left the website 4000, then which segment should the visitor be assigned to? The priority of the rules determines the outcome of the segment placement, i.e., the referral/source is more important than the landing page. In this case, the iPath engine 2000 will place the customer visitor into the “Gadget Lover” segment if the referral has a higher priority rank than the landing page. The more rules a customer visitor satisfies, the iPath engine 2000 can more accurately place the visit into an appropriate segment, thereby resulting in a greater confidence that the visitor is on the right or desired path. Preferably, the input/edit placement rules component 1108 provides a quick placement for real time assignment of visitors into an iPath, consisting of purely steps such as source—landing—next page. That is, the input/edit placement rules component 1108 using the quick placement feature can place a customer into a path within the first 2 clicks, thereby enabling real-time personalization of the visit.

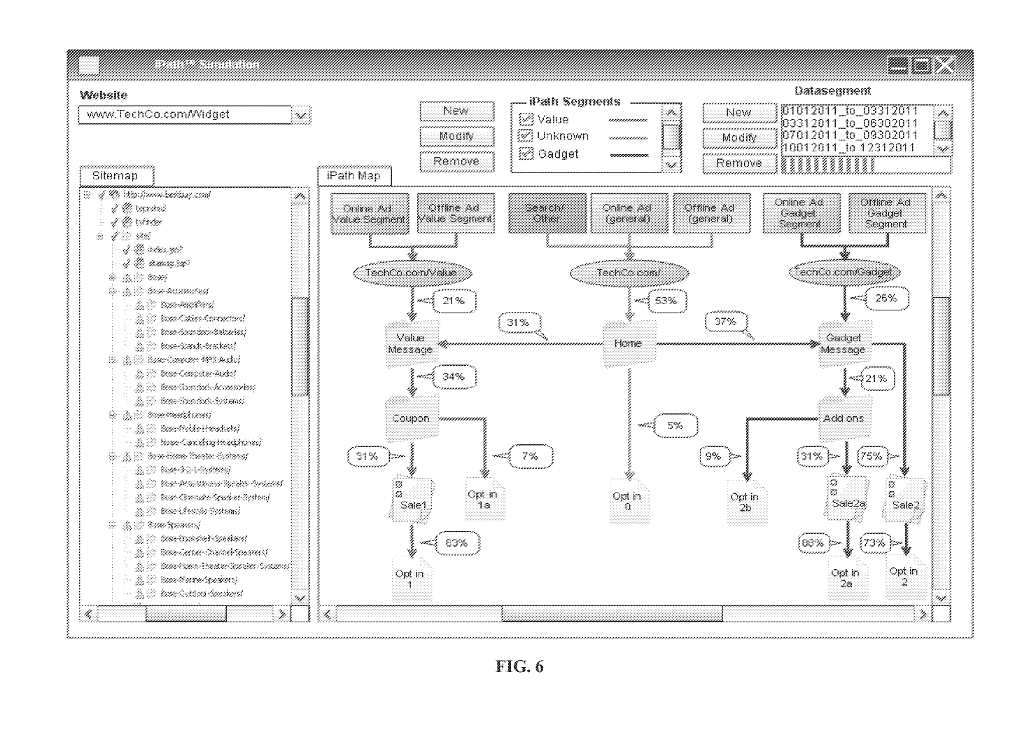

The input/edit/display simulation assumptions component 1109 displays a screen to allow user to select variables and create rules for segment assignment for a simulation. After the iPath user has selected an iPath and date range to use for a simulation using the select date range component 1105, and made any modifications to the iPath using the display/edit iPath component 1104 or the mange iPaths component 1103, the input/edit/display simulation assumptions component 1109 is invoked by the user to input assumptions about the traffic flow resulting from the hypothesis for the simulation. The iPath simulation engine 3000 stores the scores and traffic volumes between steps in a temporary table for the simulation. Turning now to FIG. 6, there is illustrated an exemplary screen shot of the input/display/edit iPath simulation assumption component 1109. The iPath user can change the volume of the traffic for a given step or source using the input/display/edit iPath simulation component 1109 and the iPath simulation engine 3000 calculates the impact of the changes on the rest of the iPath(s).

The iPath user can invoke the mange simulations component 1110 to create, modify, remove and execute simulations on the iPath simulation engine 3000. The manage simulations component 1110 allows the client or iPath user to modify an existing iPath to simulate behavioral assumptions and view the results. The input/edit/display simulation assumptions component 1109 documents the assumptions being tested by the iPath user and the manage simulations component 1110 presents the iPath user with a screen to select an existing simulation for modification, removal or execution, or create a new one. Examples might be a change in the amount or type of media buy or budget allocation, thus changing website traffic (volume). Also changes in steps or traverses due to the insertion of new pages or new steps can also affect traffic volume and path adherence. To create a simulation, the iPath user invokes the iPath simulation engine 3000 using the manage simulations component 1110 to select and copy an existing iPath to create a new iPath for simulation. In accordance with an exemplary embodiment of the claimed invention, the manage simulations component 1110 invokes other components required to create the simulation, such as, the display/edit iPath component 1104, the select date range component 1105 and the input/edit placement rules 1108, and invokes the iPath simulation engine 3000.

In accordance with an exemplary embodiment of the claimed invention, the score iPath component 1111 invokes or calls the iPath engine 2000 to process rules against the iPath data. Once an iPath is created by the create iPath component 1102, the score iPath component 1111 can calculate the iPath by selecting a date range using the select date range component 1105. The score iPath component 1111 invokes the iPath engine 2000 to calculate the scores to the iPaths/segments and the client website 4000 using a scoring algorithm, discussed herein below, based on weighting assigned to the steps of a given iPath. Taking into consideration of the weight of each iPath, the iPath engine 2000 utilizes the scoring algorithm to calculate a final client website 4000 iPath score for the selected date range.

The visualize iPath effectiveness component 1112 invokes or runs the data visualization tool 1300 using specific iPaths. Once an iPath has been created by the create iPath component 1102, the user can select a date range using the select date range 1105 and invoked the iPath effectiveness component 1112 to view the iPath effectiveness. The iPath effectiveness component 1112 invokes the data visualization tool 1300 to determine and show the path adherence on the client device 100. The data visualization tool 1300 enables the user to drill down on details in the data selected.

The manage reports component 1113 allows the iPath user to select from standard or custom reports, or to invoke the data visualization tool 1300 to create custom reports. The iPath users can produce reports from the data visualization 1300 or select reports from a standard library set up to work with the iPath database 5000.

All users of the iPath system 1000 are validated by the authenticate user component 1114 before a user can access the iPath system 1000. Preferably, each user logins with a valid user id and password that has been assigned to her. Once the user is authenticated or validated by the authenticate user component 1114, the check permissions component 1115 determines the user permissions, e.g., via a database lookup.

iPath administration functions can be performed by both the iPath system administrator and client administrator. The iPath system administrator can add, modify and remove iPath clients and iPath users. Since multiple clients will likely access the iPath system 1000, only iPath system administrator will be able set up a client administrator, who will have the ability to add websites 4000 and users to access the client related information. That is, each iPath user is associated with a client and can access only client websites 4000 and information relating to its associated client and not another client. The client administrator has all of the capabilities of a iPath user or client iPath user plus additional ability to add client iPath users, client websites 4000 and permissions for specific client iPath user to access a particular client website 4000.

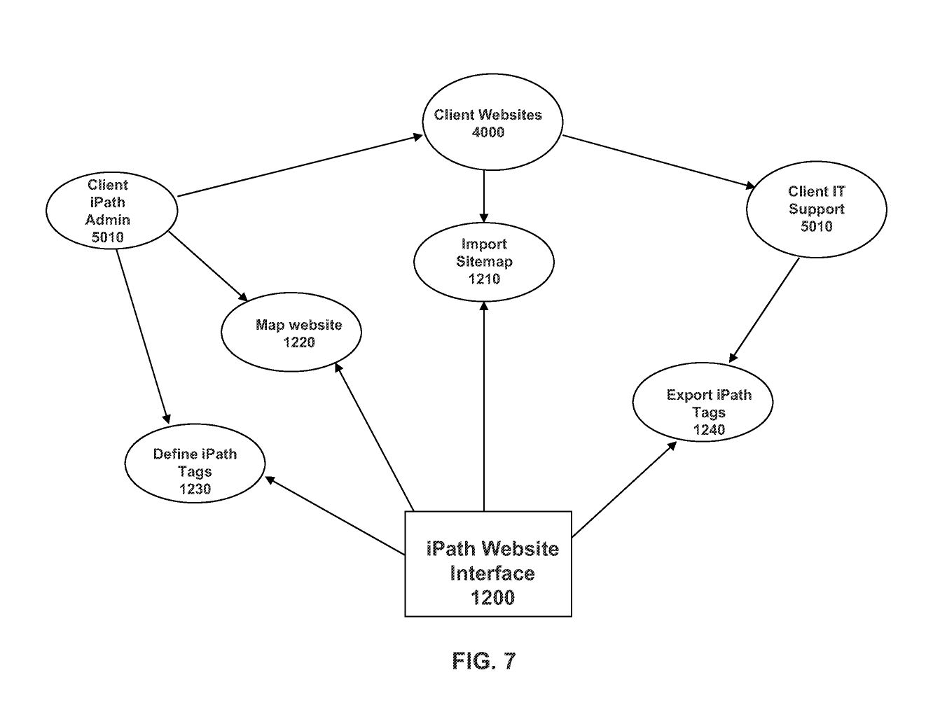

As exemplary shown in FIG. 7, the iPath website interface 1200 includes functionalities required by the iPath system 1000 to interface with the client website 4000, such as the importing of sitemaps and intelligent tagging. In accordance with an exemplary embodiment of the claimed invention, the iPath website interface 1200 is an automated real-time interface where iPath and intelligent tags are synchronized with client websites 4000. The iPath system administrator utilizes the import sitemap component 1210 of the iPath website interface 1200 to import the structure of the client website 4000, thereby enabling the iPath system 1000 to apply the iPath methodology to and communicate with the client website 4000. It is appreciated that a client website 4000 can contain multiple products or brand websites within the same directory structure. The iPath user must be able to select a physical group of pages that will be associated with the brand or product and defined for the iPath system 1000 as the website that iPaths will be created from, thereby enabling the iPath user to “pick” or drag and drop from a separate frame. Preferably, the iPath website interface 1200 stores version information in the database 5000, including but not limited to the following information: the sitemap import date and which datasets it is valid for.

The iPath website interface 1200 further comprises map website component 1220, define iPath tags component 1230 and export iPath tags component 1240. The iPath system 1000 invokes the map website component 1220 to map the structure of the client website 4000 to fields in the iPath database 5000 to facilitate the creation of iPaths and insertion of iPath Tags. The define iPath tags component 1230 assigns tags to the table defining the website structure that was imported into the iPath system 1000, and the export iPath tags component 1240 provides the iPath system 1000 with the ability to export iPath intelligent tags to the client website 4000.

The iPath data visualization tool 1300 provides data mining, visualization and reporting functionality to the iPath system 1000 to enable the iPath users to visualize and perform causal analysis of path performance. In accordance with an exemplary embodiment of the claimed invention, the iPath data visualization tool 1300 enables creation of template visualizations and custom reports for the following: adherence to paths (or lack thereof); patterns of abandonment; patterns of payoff; performance of media; individual iPath scores; client website 4000 iPath score; and other customized fields. The iPath data visualization tool 1300 will provide these reports for visualizations of individual iPaths or all paths at a client website 4000. The iPath users must select a data range (e.g., using the select date range component 1105) to view the reports, and/or drill down to see path adherence.

The iPath data visualization tool 1300 comprises the following exemplary components: a create/modify/remove standard templates component 1310, a create/modify/remove custom reports component 1320, and a run report component 1330. The iPath user can invoke the create/modify/remove standard templates component 1310 of the data visualization tool 1300 to create standard templates that can be used to generate a report when provided with an iPath and date range combination. That is, the create/modify/remove standard templates component 1310 of the data visualization tool 1300 makes the standard templates accessible to the users for generating standard reports. The iPath user can invoked the create/modify/remove custom reports component 1320 of the data visualization tool 1300 to generate custom templates when provided with an iPath and date range combination. After invoking either the create/modify/remove standard templates component 1310 or the create/modify/remove custom reports component 1320 to create standard or custom reports, the run report component 1330 executes or generates either the standard or customer report, based on 1310 or 1320) using the provided iPath, data range and output option.

In accordance with an exemplary embodiment of the claimed invention, when the rules engine, iPath analytical system or iPath engine 2000 is invoked from the iPath user interface 1100 by the iPath user, the iPath engine 2000 takes the segment definitions input for the requested website 4000 and process the selected data, placing the individual session (website visit) within the selected data into a specific iPath based on the segmentation rules. Additionally, the iPath engine 2000 calculates the iPath scores for the data selected using the scoring algorithm described herein. Further, the iPath engine 2000 can be invoked from the iPath ETL utility, as described herein. Preferably, iPath system 1000 is enabled for real-time transactions and the iPath engine 2000 can be invoked from the iPath website interface 1200 using intelligent tags.

The iPath system 1000, particularly the operation of the iPath engine 2000, is now described herein with an exemplary case study of a mature branded pharmaceutical company as a client. The exemplary mature branded pharmaceutical company's allergy drug was steadily losing its market share, holding its third position within a three-competitor race. Despite its team winning awards for well-produced TV and digital advertizing, its product sales lagged. The newly-appointed product manager decided to change the marketing tactic and embrace an IMC strategy. The strategy called for personalization of marketing messages and leveraging the product website to serve as the focal point in the delivery of these key messages. As the new marketing blitz began, the product manager asked “As the website is now one of the most important components of my overall marketing strategy, how do I know it is working as we intended?” The iPath system solved her problem.

During the iPath discovery phase, iPath implementers worked with the product manager, product ad agency, and IT support staff to identify three key customer segments:
parents who fill prescriptions for their children
new patients who need an allergy drug that is right for them
patients who are unhappy with their current allergy drug and are looking to switch

The client team played a central role in creating optimal paths with unique steps using the iPath system 1000. These steps consisted of individual or multiple web pages and discrete actions (such as opting into a vendor's product information service). The different web pages contained messages and content specific to each of the distinct paths. Associated with each path were business rules used to place online visitors into specific market segments and to coordinate online messaging/content that would be of most interest to the visitor (i.e., considered to be of highest value to the visitor). Based on the iPath analysis by the iPath system 1000, the client was now able to proactively tailor online marketing and content to best fit specific visitor segments. With the iPath system 1000, the client was also able to measure marketing campaign and online content effectiveness in keeping visitors along defined optimal paths toward valued outcomes.

For example, a mother filling a prescription for her child is most interested in learning dosage and safety information, while a new patient most wants to know why this drug may help him feel better. To ensure adherence to these higher-value paths, website navigation was changed, based on the analysis performed by the iPath system 1000, to enable visitors to more quickly self-identify and more quickly navigate to their respective paths. Once the client website 4000 was enabled for iPath system 1000, the client was able to identify obstructions that hindered visitors' movement along high-value paths. A specific example would be a coupon that had earlier been placed as a payoff along one of the paths. Direct linkage to that coupon carried the visitor through several online coupon sites, thus, interrupting visitor segment path flow and disrupting key marketing assumptions. Once this flow disruption was identified by the iPath system 1000, the client ensured that coupons were no longer directly linked outside of the product website. The result was greatly improved path adherence on the part of online visitors and significantly better measurement of online campaign ROI, respective of specific customer segments.

Employing design for measurability precepts, the iPath analytical framework was used to yield immediate insights and improvements:
a. Reallocation and optimization of millions of dollars across different media channels, on its own yielding a return several times the investment;
b. Consistent alignment of marketing activities around a set of defined, observable behavior paths to payoff; computing and optimizing the key drivers to payoff resulting in improved iPath score that more than doubling program effectiveness;
c. Shaping customers' behavior on and off a website, guiding them along preferred paths and thus, conveying greater benefit and valued customer;
d. Validation of the integrated marketing strategy and improvement of its execution; and
e. The analysis and insights were a critical component to the product's ascension to taking over the top position of its market and growing revenue from $300 M to over $1 B per year in less than three years.

The iPath methodology is an approach to marketing founded on web-based relationship marketing and the fact that every customer interaction has potential value. A successful interaction is one that achieves an outcome consistent with brand goals. For example, a successful exchange of information with a loyal customer may have greater value than a purchase by a price-shopper. Though monetizing every interaction is not always possible or even desirable, understanding whether or not a positive outcome is achieved (or, conversely, a negative one is avoided) is a critical requirement of marketing effectiveness.

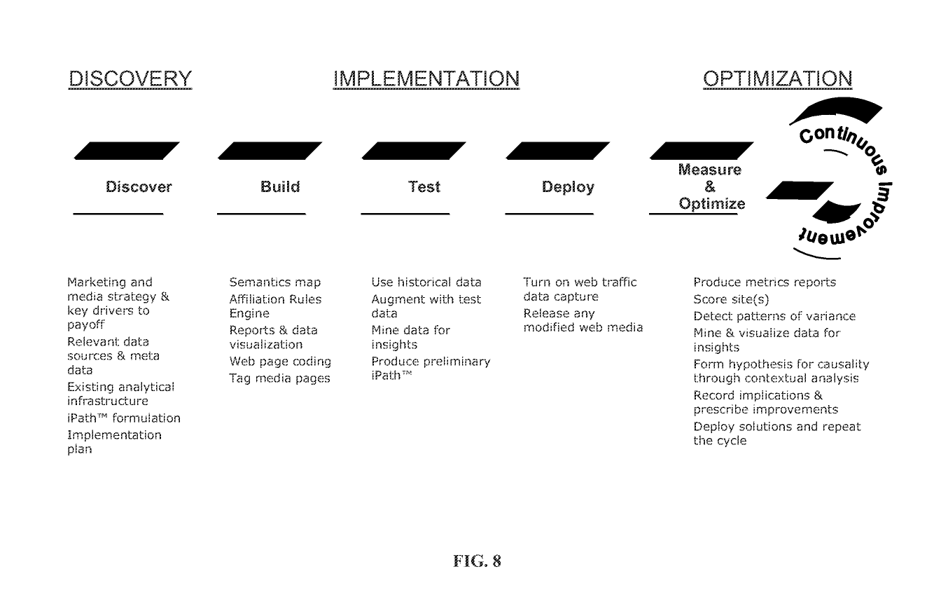

As shown in FIG. 8, in accordance with an exemplary embodiment of the claimed invention, the iPath methodology comprises three parts: Discovery, implementation (Build, Test, and Deploy), and Optimization (Measure & Optimize). During the Discovery phase, the iPath system focuses on formulating: a) key driver assumptions; b) iPath formulation; c) technology Architecture for iPath Deployment; and d) Implementation plan.

During the Implementation and optimization phases, the iPath system 1000 deploys data mining, data modeling, and filters; the iPath system 1000 builds the system framework for monitoring and analyzing client website 4000, and hypotheses are tested using iPath simulation engine 3000 before actual deployment on the client's server(s). The product of the implementation phase is a customer facing website that can have an imbedded intelligent tagging system for data collection/reporting tools to analyze, calculate, and fine-tune the iPath score. The optimization phase is the steady-state operation of the iPath platform or system 1000. While optimization in the steady state is typically a customer-owned activity, the first optimization cycle is typically included as part of implementation.

The data and rules derived from the discovery phase become input to three sequential components which comprise the crux of the iPath system 1000:
a. Filter Component: Web data is filtered to exclude immaterial traffic (spiders and spurious visits deemed accidental). The filter component comprises the iPath ETL utility 1400 and iPath engine 2000.
b. Identity Component: Each visit is assessed as to its most likely source, the target segment it represents, and the desired path it should follow. The identity component comprises the iPath user interface 1100.
c. Scoring Component: The visit is scored and compiled with all other visits to arrive at the iPath Score. The scoring component comprises the iPath engine 2000.

Additional diagnostic analysis and data visualization is baselined by the iPath system 1000 to identify weaknesses in the path to payoff, media performance, call to action, or hypotheses in general. Remediation is then measured against this baseline.

In accordance with an exemplary embodiment of the claimed invention, the iPath system 1000 performs three activities in increasing complexity: 1) construct an iPath rule set based on data analysis from the Filter and Identity components using iPath user interface 1100, iPath engine 2000, and iPath ETL utility 1400; 2) construct a slate of iPath reports to provide greater insight into key measures which can help to prescribe focus areas for improving program effectiveness using iPath data visualization tool 1300; and 3) ad hoc data interrogation, using data mining and visualization techniques, to enable detailed inspection of specific issues as they arise using iPath user interface 1100 and iPath data visualization tool 1300.

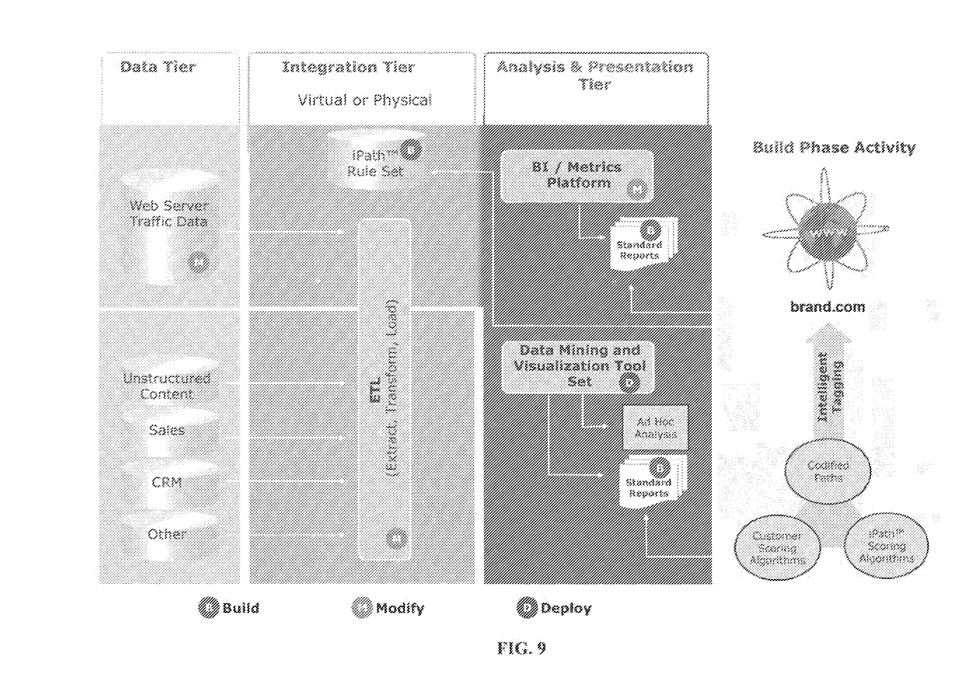

In accordance with an exemplary embodiment of the claimed invention, the iPath implementation on the client's web server(s) comprises these steps:
a. a rule set which codifies all desirable paths and associated market segments;
b. intelligent tagging of web properties and expansion as needed for information captured by web servers;
c. deployment of a data mining and visualization solution, where needed;
d. deploying iPath components within the existing infrastructure, as exemplary illustrated in FIG. 9;
e. data collection, measurement and analysis for initial iPath scoring.
f. optimization plan for continuous improvement of website effectiveness and the iPath score

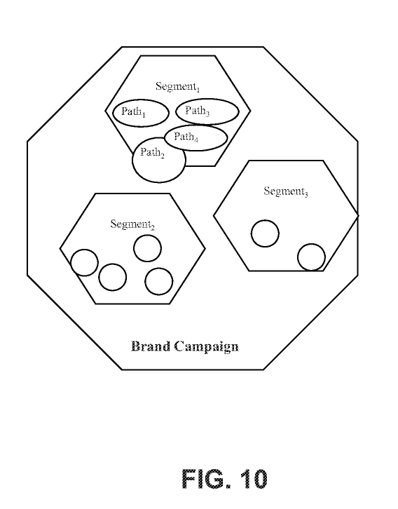

As exemplary shown in FIG. 10, in accordance with an exemplary embodiment of the claimed invention, an iPath score is inherently hierarchical, allowing for the optimization of component programs, or the integration within larger marketing campaigns. For example, a marketing campaign targeting a specific market segment will have a score that is a function of the paths which comprise it. Conversely, the larger brand marketing score is a function of all the distinct targeted campaigns which it comprises.

As exemplary shown in FIG. 10, the score for Segment₁ is a function of the score for paths 1-4. Hence:

iPath(Segment₁)≡f[iPath(Path₁),iPath(Path₂),iPath(Path₃),iPath(Path₄)].

Likewise, the score for entire brand campaign is a function of the scores for Segments 1, 2, & 3. Hence:

iPath(Brand Campaign)≡f[iPath(Segment₁),iPath(Segment₂),iPath(Segment₃)].

Accordingly, the general formula for the iPath Score is expressed as the weighted average of all component iPath scores. That is:

$$Equation 1 \text{:} iPath Score Calculation$$

$$iPath = \frac{{\sum }_{i = 1}^{t} {ω}_{i} {n}_{i} {Y}_{i}}{{\sum }_{i = 1}^{t} {ω}_{i} {n}_{i}} where$$

$${Y}_{i} = iPath score of path i , \\ {ω}_{i} = relative weight ( value ) assigned to path i , \\ {n}_{i} = number of visitors to Path i$$

$$t = total iPath paths .$$

The calculation of the component path score (Yᵢ) is the average outcome of every real (observed) traversal of pathᵢ: Hence:

$$Equation 2 \text{:} Path x iPath Calculation$$

$${Y}_{x} = \frac{{\sum }_{i = 1}^{{n}_{x}} {Ω}_{x , i}}{{n}_{x}} where$$

$${Ω}_{x , i} = payoff of path x , and visit i$$

$${n}_{x} = the number of traversals for path x$$

Alternatively, it will often be convenient and conceptually simpler for the iPath analytical system to aggregate like outcomes. That is, if there are 3 possible payoffs for a specific path, say a, b, and c, and the number of visitors to the specific path at each payoff point are N(a), N(b), and N(c), respectively, then the iPath analytical system or engine 2000 computes the iPath score for that path by the weighted average of the 3 payoffs or:

$$\frac{[ a \times N ( a ) ] + [ b \times N ( b ) ] + [ c \times N ( c ) ]}{N ( a ) + N ( b ) + N ( c )} .$$

For the purposes of analyzing and improving campaign effectiveness, the iPath system 1000 employs logistic regression to fit a function to the observed outcomes. Doing so reveals the key drivers which, if they can be adjusted, can point to the most potent levers to affect campaign performance. Examples of drivers can include, but is not limited to: referral source, time of visit, length of visit, number of pages visited, customer segment, number of visits, URL, search terms, page visited, geographical region, device type, volunteered information, repeat visit, and campaign response.

A predictive function or expected value of any random visit to path, is then a function of the key drivers. Hence: E(Yᵢ)=f(d₁,d₂, . . . ,dₘ) where dᵢ is the i^{th} key driver of m total key drivers.

IPath Score Example: An on-line company “TechCo” selling a consumer technology device wants to launch an integrated marketing campaign utilizing both traditional and digital media. For simplicity, TechCo divides its market into just 2 target segments: gadget lovers and value shoppers. Table 1 lists media goals, while Table 2 summarizes the marketing goals and payoffs.

TABLE 1
TechCo Media Goals

| | General | Targeted |
|---|---|---|
| Offline | Create positive impression | Create market interest within |
| | and interest for TechCo and | specific segments with |
| | TechCo.com with a mixed | appropriate technophile or |
| | value/feature message | value messaging and media |
| | | placement. Drive consumers |
| | | to segment-specific landing |
| | | pages on TechCo.com |
| Online | Leverage/Reinforce offline | Leverage/Reinforce offline |
| | campaign with stronger call | campaign with value/gadget |
| | to click and direct link to | media placement and strong |
| | TechCo.com | call to click through to segment- |
| | | specific landing pages |

TABLE 2
Goals and Payoffs per Path

| | Gadget Lover | Value Shopper |
|---|---|---|
| Marketing | Penetrate technophile | Convert shoppers to buyers with |
| Goals | market through device | coupons and value per dollar |
| | sales and up-sell through | appeal. |
| | peripherals and add-ons. | |
| Payoffs/ | Device sale | Device sale |
| Outcomes | Sale of peripherals/add-ons | Opt-in to marketing |
| | Opt-in to marketing | communications |
| | communications | |

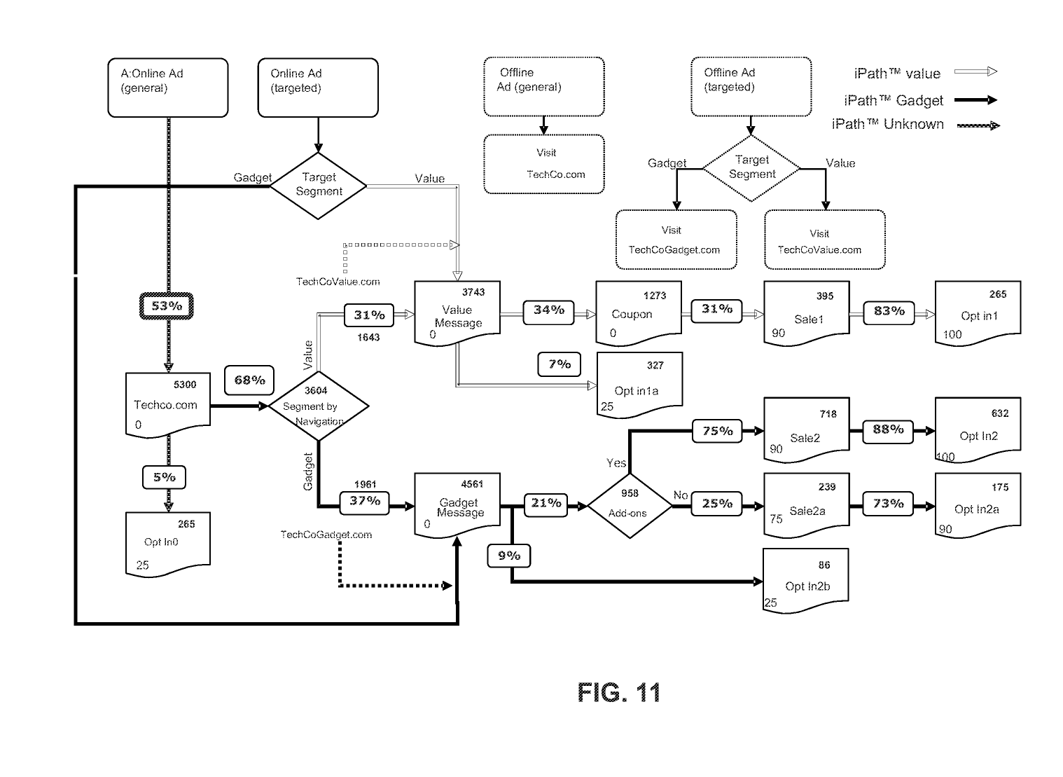

FIG. 11 shows the exemplary iPaths, and iPath weights assigned to possible payoffs (outcomes) for each iPath by the iPath users using the iPath user interface 1100. It is appreciated that a step can contain multiple web pages or just one web page. The home page is typically the beginning step of a path. The iPaths in this example are the value path, gadget path, and the unknown path. The weights are, for example, ‘90’ assigned to ‘Sale1’ and ‘100’ assigned to ‘Opt In1’ of the value path, while ‘75’ assigned to ‘Sale2a’ and ‘90’ assigned to ‘Opt In2a’ of the gadget path. In the example shown in FIG. 11, a visitor may enter or learned of the client website 4000 from four possible sources: online Ad (general), Online Ad (targeted), Offline Ad (general), Offline Ad (targeted). If a gadget lover visiting the client website 4000 is from a targeted online ad source, he would land in the Target Segment step and based on his love of gadgets, move on to Gadget Message step. From there, he is given a choice of buying add-ons to his product of choice, or if he decided not to make a purchase, he could choose to opt in using the Opt In2b step. At this point, the iPath engine 2000 would assign a score of 25 points to the iPath gadget based on the weight assigned to the Opt In2b step. If he made a purchase but not an add-on, he would have the choice to make a purchase at Sale2a step then opt in. At this point, the iPath engine 2000 would assign a score of 90 points to the iPath gadget as he exited the path at Opt In2a which had a weight of 90. If he made a purchase with an add-on, then opted in, then the iPath engine 2000 would assign a score of 100 points to the iPath gadget as he exited at Opt In2 with a weight of 100. If he purchased an add-on product but did not opt in, the iPath engine 200—would assign a score of 90 points to the iPath gadget as he exited at Sale2 page with 90 as its weight. If the gadget lover learned of the product from a general offline ad, he would be directed to visit TechCo.com page/step. From there he would be given a navigational choice of visiting the Value Message step or Gadget Message step. Once he clicked to the Gadget Message step, his choices would be the same as the earlier scenario noted herein. If the gadget lover learned of the product from a targeted offline ad, he would be directed to visit the TechCoGadget.com page/step which was the same as the Gadget Message step. From there, his choices would be the same as the earlier scenario noted herein.

Similar logic applies to value shopper visitors and unknown visitors. For an unknown visitor, she could come from a general online or offline ad that directed her to the TechCo.com page/step then exit. If she opted in at the Opt In0 step before exiting the client website 4000, the iPath engine 2000 would assign a score of 25 points to the iPath unknown, the maximum score the iPath unknown could be assigned. These weights and the paths themselves reflect the marketing as outlined herein. To be sure, in a real-world scenario, there would almost certainly be more payoffs associated with non-sales outcomes. For simplicity, in FIG. 11, paths associated with product servicing, other product e-commerce activity, and activity associated with marketing communications response have been excluded. Using the traffic volume exemplary shown on each of the iPath steps such as 4561 on Gadget message step, 239 on sales2a step, the iPath engine 2000 determines or calculates the individual iPath score by applying Equation 2. Table 3 further clarifies the site visitor traffic assumptions and the visitor volume for each of the steps per the individual path.

In this iPath score example, an assumption has been made that 10,000 visitors have traversed TechCo.com in a single week and the website performs as reflected in Table 3.

TABLE 3
TechCo Performance

| Path | Page | Entry* Point | Total Visits | Exit* Point | Value | Abandon | Payoff | iPath |
|---|---|---|---|---|---|---|---|---|
| UNKNOWN | TechCo Home | 5,300 | 5,300 | 1,431 | 0 | 84.4% | 15.6% | |
| | Opt-in0 | — | 265 | 265 | 25 | | | |
| | | | | 1,696 | | 1,431 | 265 | 3.9 |
| Value | Value Msg | 2,100 | 3,743 | 2,208 | 0 | 82.5% | 17.5% | |
| | Opt-in1a | — | 262 | 262 | 25 | | | |
| | Coupon | — | 1,273 | 878 | 0 | | | |
| | Sale1 | — | 395 | 67 | 90 | | | |
| | Opt-in1 | — | 327 | 327 | 100 | | | |
| | | | | 3,743 | | 3,086 | 657 | 12.1 |
| Gadget | Gadget Msg | 2,600 | 4,561 | 3,193 | 0 | 70.0% | 30.0% | |
| | Opt-in2b | — | 410 | 410 | 25 | | | |
| | Add-ons | — | 958 | 0 | 0 | | | |
| | Sale2 | — | 718 | 86 | 90 | | | |
| | Opt-in2 | — | 632 | 632 | 100 | | | |
| | Sale2a | — | 239 | 65 | 75 | | | |
| | Opt-in2a | — | 175 | 175 | 90 | | | |
| | | | | 4,561 | | 3,193 | 1,368 | 22.3 |
| | | 10,000 | | 10,000 | | 77.1% | 22.9% | |
| | | | | | | 7,710 | 2,290 | |

*Total visits = 10,000.
“Entry point” is the number who enter the web site via that page.
“Exit point” is the number leaving the site on that page.

In this example, the iPath analytical system or engine 2000 applies Equation 2 (Path×iPath calculation):

$${iPath}_{Gadget} = \frac{{\sum }_{i = 1}^{{n}_{x}} {Ω}_{x , i}}{{n}_{x}} = \frac{\begin{matrix}( 410 \times 25 ) + ( 86 \times 90 ) + ( 632 \times 100 ) + ( 65 \times 75 ) + ( 175 \times 90 ) \\ ( 65 \times 75 ) + ( 175 \times 90 )\end{matrix}}{4 , 561} = 22.3$$

$${iPath}_{Value} = \frac{( 262 \times 25 ) + ( 67 \times 90 ) + ( 327 \times 100 )}{3 , 743} = 12.1$$

There is also an “unknown” element that must be accounted for by the iPath analytical system or engine 2000: visitors who abandoned before their path could be determined. And even if there were no positive outcomes for this contingent, it is important to include them for the purposes of understanding the overall effectiveness (It is essentially a reflection of the effectiveness of the home page to influence visitors to go deeper and commit to a path on the website.)

$${iPath}_{Unknown} = \frac{265 \times 25}{1 , 696} = 3.9$$

To compute the overall iPath score using Equation 1, in accordance with an exemplary embodiment of the claimed invention, the iPath analytical system or engine 2000 considers whether there is an additional weighting to apply to reflect the value of a particular path to the client versus relative to others. In this case, TechCo has determined that the lifetime value of Gadget Lovers is twice that of other customers. Hence, the iPath analytical system or engine 2000 applies following weight matrix:

└ω_{Unknown} ω_{Value} ω_{Gadget}┘=[1 1 2].

Applying Equation 1:

$${iPath}_{TechCo} = \frac{( 1 \times 1 , 696 \times 3.9 ) + ( 1 \times 3 , 737 \times 12.1 ) + ( 2 \times 4 , 567 \times 22.3 )}{( 1 \times 1 , 696 ) + ( 1 \times 3 , 737 ) + ( 2 \times 4 , 567 )} = 17.6$$

Increasing the conversion from the home page would result in a significant improvement in TechCo's score. If the iPath analytical system or engine 2000 determines that most of the traffic to the home page was the result of general marketing versus targeted, then an examination of the relative investment of general versus targeted marketing would be warranted and a shift of spending from general to segment-specific could greatly increase TechCo's iPath score.

As demonstrated, unlike typical web analytic system that focus on the macro analysis of overall website data, the iPath system 1000 leverages data mining, data modeling, and regression analysis to articulate marketing goals and design preferred behavioral paths for web visitors. In accordance with an exemplary embodiment of the claimed invention, the iPath analytical system or engine 2000 links campaign components' performance to a quantifiable outcome (payoff), and defines optimal customer behavior, respective of campaign goals. As a result, the iPath system 1000 can quantitatively measure where and why customers diverge from the path, and use the knowledge to continually to improve marketing strategies. The result is greater visitor adherence to preferred paths and attainment of desired outcomes.

The iPath system 1000 can help clients create a more effective marketing communications program by: a) linking campaign component performance to actual payoffs, thus allowing optimal allocation of marketing investment to achieve a better ROI; b) shaping customers' behavior on company websites 4000, guiding them on the preferred paths and thus, fostering an intimate relationship with customers; and c) validating customer and market segment assumptions to ensure marketing goals and priorities are consistent across differing media.

In accordance with an exemplary embodiment of the claimed invention, the iPath system 1000 assigns customer segments to iPaths based on key attributes. For every customer segment, an iPath for those visitors to travel on the website 4000 will be defined. A segment is defined by a set of business rules that are processed in priority order to assign a visitor to a segment (iPath). The iPath or rules engine 2000 examines the following exemplary (non-exhaustive) key attributes to assign a segment: steps traversed, landing page, referral source, search terms, exit page, payoff page and intelligent tags are just some of the attributes. Users will create business rules using some or all of the above key attributes that assign visitor to a segment, constructing logical conditions based on the values of the key attributes (e.g., landing page=“coupon” and referral page=“bargain-site). Rules will also be assigned a priority so that if more than one rule applies, then the iPath engine 2000 gives preference to the rule with the highest priority. If there is a tie, i.e., there are two rules at the highest priority level, then the iPath engine 2000 uses the secondary rules to determine the winner.

For example, the “Gadget Lover” path may have the following rules associated with it to ensure visitors to the website 4000 are placed properly in the “Gadget Lover” segment versus the “Value Shopper” segment. Referring to Table 4, if a visitor came from a referring website identified for the “Gadget Lover” segment, then landed on the “Gadget Lover” message page, and then viewed the featured product page for the “Gadget Lover,” then the iPath rule engine 2000 will place that visitor in the “Gadget Lover” segment. However, if a visitor came from one of the referral sites identified for “Gadget Lovers” but went to the “Value Shopper” message page, then left the client website 4000, then what segment should the iPath engine 2000 assign the visitor? In this case, the iPath engine 2000 will apply the established priority of the rules as exemplary set forth in Table 4 to determine that the referral/source is more important than the landing page and will thus place the visitor in the “Gadget Lover” segment. The more rules a visitor satisfies, the iPath engine 2000 can more accurately place the visit (or visitor) into the appropriate segment, thereby increasing the confidence level that the visitor is on the right path.

In accordance with an exemplary embodiment of the claimed invention, the iPath engine 2000 can provide “quick placement” for real time assignment of visitors into an iPath, consisting of steps such as source—landing—next page. In the quick placement mode, the iPath engine 2000 places the visitor into a path within the first 2 or 3 clicks to enable real-time personalization of the visit.

TABLE 4

| Rule# | Segment | Priority | Rule Description | Condition | Attribute | Value(s) |
|---|---|---|---|---|---|---|
| 1 | Gadget | 1 | Referral source matches to a gadget | OR | Referral | www.cnet.com; |
| | | | lover defined source | | Source | www.gadget.com |
| 2 | Gadget | 1 | Visitor went from Landing Page to | AND | Traverse | Landing to Featured Product |
| | | | Featured Product Page | | | Featured Product to Opt-In |
| 3 | Gadget | 3 | Visitor arrived on Gadget Message | EQUAL | Landing | www.techco/gadgetmsg |
| | | | | | Page | |
| 4 | Gadget | 1 | Visitor purchased from Gadget | EQUAL | Step | Payoff |
| | | | Segment | | | |
| 5 | Gadget | 2 | Visitor arrived via search engine term | OR | Search | Gizmo, Flash Memory |
| | | | identified for segment | | Terms | |

In accordance with an exemplary embodiment of the claimed invention, the iPath engine 2000 has machine learning capabilities to improve its segmentation capability, especially with regard to real-time quick placement. In the case of tagging that allows real-time quick placement, users will input segmentation rules that allow the iPath engine 2000 to place a session (website visitor) in a path within the first two (2) clicks. The iPath engine 2000 then tracks the entire session to ensure the validity of the quick placement. Based on the history, the iPath engine 2000 refines the quick placement algorithm to ensure a higher confidence level in the subsequent quick placement.

In accordance with the exemplary embodiment of the claimed invention, the iPath engine 2000 comprises a self-improving segment placement engine 2100 such that iPath segment assignment is self-improving. As more visitors traffic a website 4000, observed behavior is compiled into iPath's collective knowledge store (iPath database 5000). The initial algorithms utilized by the segment placement engine 2100 for assigning visitors into segments are based on evidence of correlation between the psychographics—needs and interests—which describe the segment, and the behavior and attributes observed from their on-line interactions. As the collective knowledge store grows, the accuracy of the segmentation engine 2100's assignment of the segment improves. Subsequent interactions with converted customers will lead to highly accurate assignments, and will ratify or impugn the accuracy of the initial assignment by the segmentation engine 2100. All observable attributes, whether or not they were used in the initial assignment, can be re-surfaced in order to develop stronger, highly accurate assignments by the segmentation engine 2100.

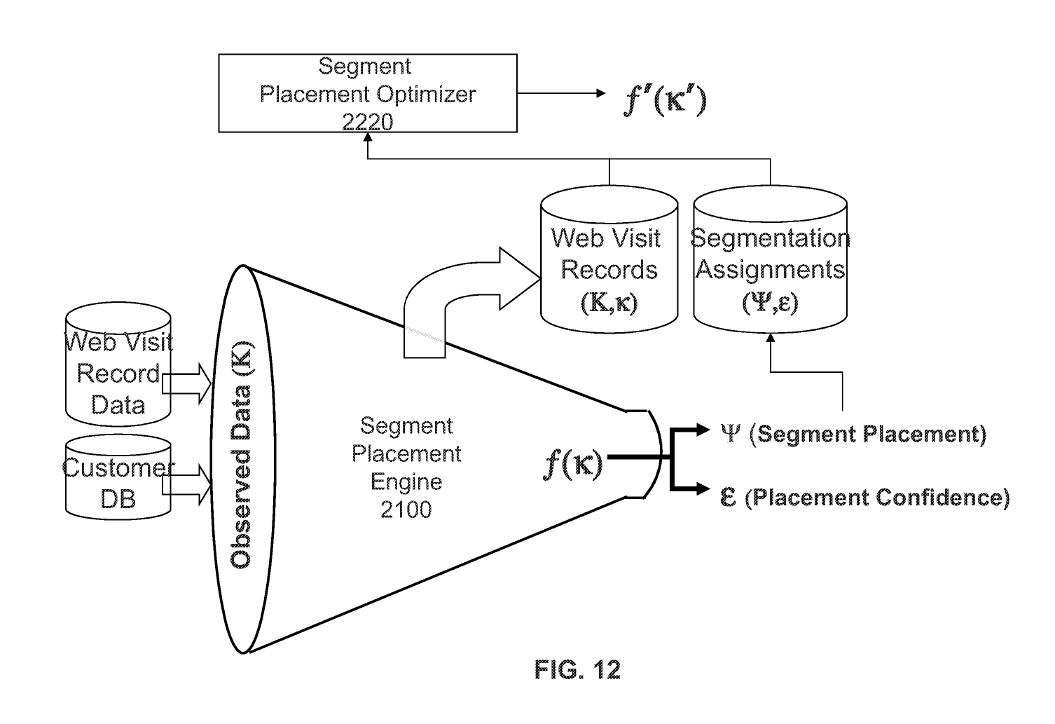

Turning now to FIG. 12, there is illustrated an exemplary segment placement optimizer 2200 of the segment placement engine 2100 for retrospective assignment of segment. K represents all observed data associated with a visit. But only a subset (κ) of that data informs the assignment. For example, κ may consist of referral source, landing page, local time because only those factors are deemed relevant to the segment assignment function by the segment placement engine 2100. Other factors may be in K, such as browser and device, but they are seen as neutral and objective attributes until new information suggests otherwise. Initially, the segment placement engine 2100 examines k and places the on-line visitor session into a specific segment Ψ and calculates a placement confidence score of ε.

In accordance with an exemplary embodiment of the claimed invention, the segment placement optimizer 2200 will then take as input all segment placements and confidence scores, and re-examines past segmentation assignments to look for common patterns and additional variables which might improve accuracy. In accordance with an aspect of the claimed invention, the segment placement optimizer 2200 employs regression analysis on the visits for which assignment accuracy is high. New variables once thought to be neutral to the equation may emerge as suggestive attributes. A new data set κ′ includes these new variables—and may drop some of the old variables. If these new variables are more easily observable (e.g., device, browser), then the improvement accrues to all visits. The new assignment algorithm f′(κ′) then becomes the de facto algorithm for all subsequent assignments by the segment placement engine 2100. In accordance with an aspect of the claimed invention, the segment placement optimizer 2200 employs neural networks and pattern matching to recognize similarities of observed behavior to those correlated with segmentation attributes. It is appreciated that the segment placement optimizer 2200 can employ either regression analysis or neural networks and pattern matching to enable the segment placement engine 2100 to optimize the assignment of segments.

In accordance with an exemplary embodiment of the claimed invention, the segment placement engine 2100 employs real-time segmentation to improve segment assignment at every time increment. The preponderance of data shows that early recognition of segment membership with appropriate messaging leads to much lower abandonment and greater conversion. Being able to make accurate assignments early in the visit enables real-time segmentation by the segment placement engine 2100. Creating an ever-increasing experience base from which to recognize early indicators of segment-specific behaviors and attributes by the segment placement engine 2100 gives rise to autonomic segmentation.

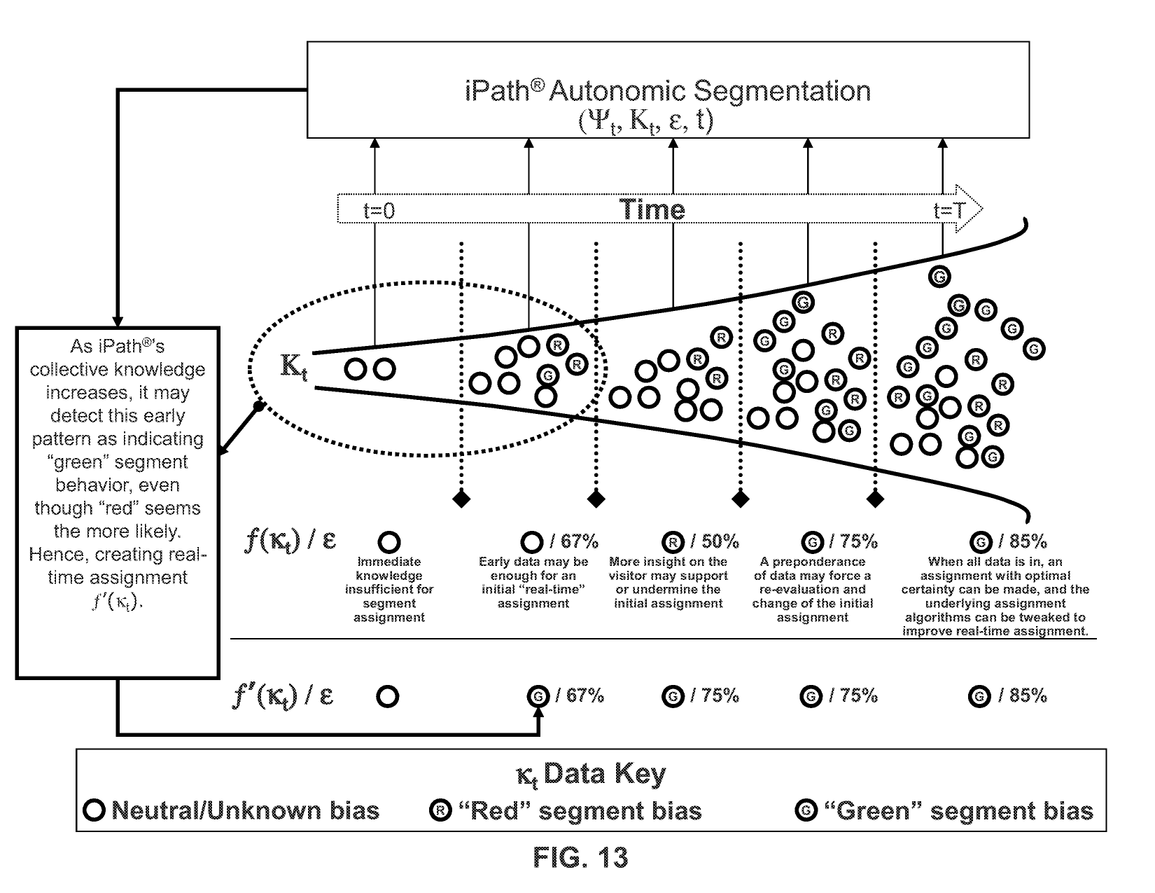

Turning now to FIG. 13, there is shown autonomic segmentation illustrating real-time segment assignments by the segment placement engine 2100. As more time (t) passes within a visit, more data (Kₜ)—observed or proffered—is collected by the segment placement engine 2100. Some of these data will indicate bias towards the “red” segment (shown as letter “R” enclosed by a circle in FIG. 13), others to the “green” segment (shown as letter “G” enclosed by a circle in FIG. 13), and still others represent no bias at all (shown as blank circles in FIG. 13). Those that indicate bias (red and green segments) comprise κₜ. As time passes, more web pages are visited, more actions are taken, and more data (blank circles, R circles and G circles) are discovered which inform the assignment function f(κₜ). The time series of data (Ψₜ, Kₜ, ε, t) form an experience base upon which higher accuracy can be gained at any interval t. Though an early assignment may prove to be erroneous today, the iPath system's collective experience will be leveraged through autonomic segmentation by the segment placement engine 2100 to recognize patterns and attributes which predict future behavior, and, hence, likely segment membership with ever-increasing accuracy.

Whether logistic regression or neural networks or other comparable method is utilized by the iPath engine 2000, autonomic can lead to counter-intuitive conclusions, but informed by a broad knowledge base across a myriad of sites, makes the iPath system 1000 expertly intuitive.

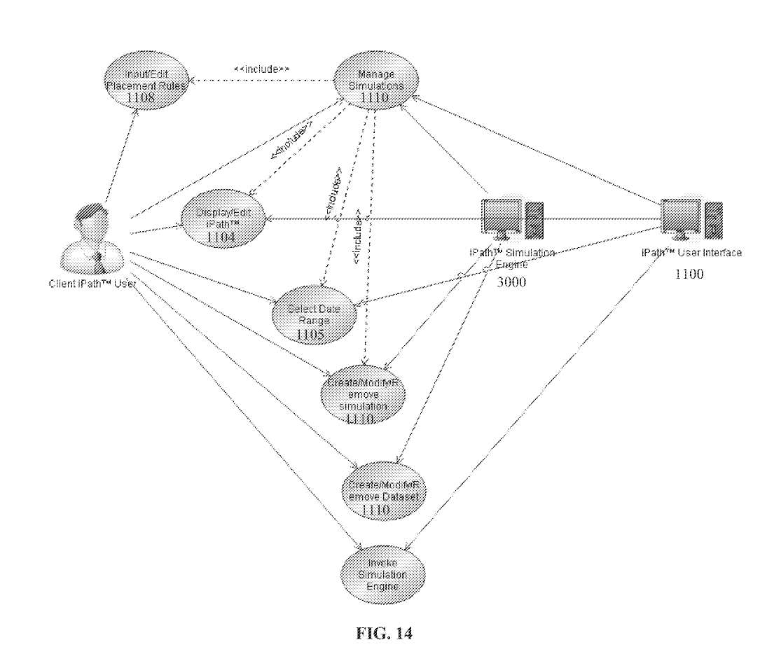

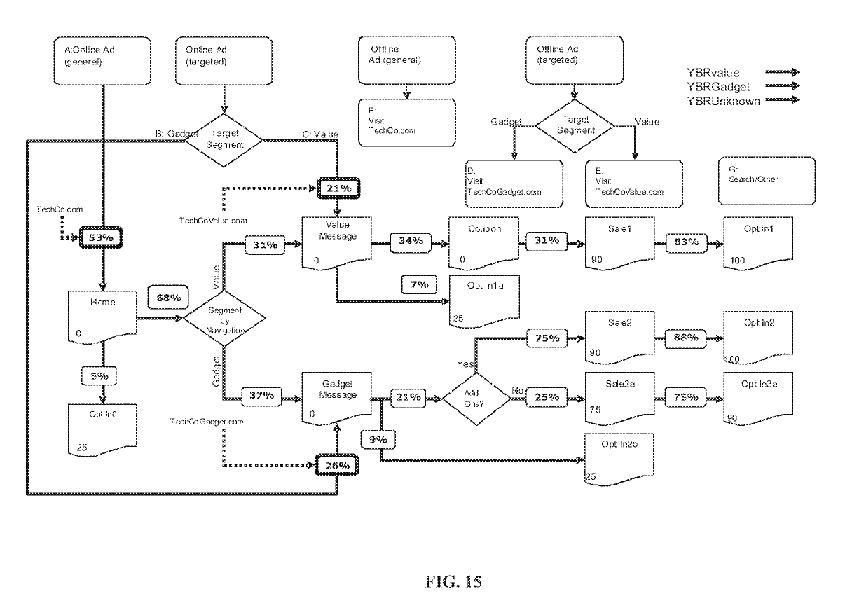

Turning now to FIG. 14, there is illustrated an exemplary iPath simulation engine 3000 in accordance with an exemplary embodiment of the claimed invention. The simulation engine 3000 is invoked from the iPath user interface 100 by selecting the option to the manage simulations component 1110 by the user. From the manage simulations component 1110, the user selects the iPath to be modified and the date range to be used for the simulation. That is, the iPath simulation engine 3000 enables an iPath user to model changes in business assumptions before actually implementing the change in their website 4000. For example, as shown in FIG. 15, the simulation engine 3000 will allow users to re-process date ranges to simulate the impact of changing an existing path, or model new scores and click-through volumes based on changing the key attributes. The simulation engine 3000 will not update the iPath database 5000 but create a temporary dataset that can be used for reporting purposes with the iPath data visualization tool 1300.

The iPath user can change the volume for a given step or source and the iPath simulation engine 3000 calculates the impact of the changes on the rest of the iPath(s). Simulations start with a hypothesis about the effect of the change. In the case of inserting a new step, some exemplary statements are as follows:
The probability of traversing the new step from feeder step “n” will be “xx”%.
The expected drop in non-abandonment will be “xx”%.
The likelihood of reaching payoff will improve “xx”%.
Self-Identification will improve “xx”%.
Click-through from step “n” to step “n+1” will improve “xx”%.

In accordance with an exemplary embodiment of the claimed invention, the simulation engine 3000 is invoked by the user interface 1100 to run through the range of data specified and use the updated business rules and iPath selected by the user. The simulation engine 3000 generates a data set that can be shown on the simulation display, or a special data set can be set aside for use by the data visualization tool 1300. In order to create a simulation, the simulation engine 3000 creates a data set from the iPath database 5000 that can also be used by the data visualization tool 1300 to show how the new assumptions will affect traffic flow between each of the paths, and steps within the path.

As exemplary shown in FIG. 15, a user wanted to test a hypothesis of placing a media buy to clear out a particular inventory, thus, targeting the value shoppers. To invoke simulation engine 3000, user first selects a time period to test the hypothesis such as running the ad campaign targeting the value shoppers for 7 days. The iPath simulation engine 3000 will then use the most recent 7 day date range to select data from the iPath database 5000 and perform a historical traffic flow analysis. As exemplary shown in FIG. 15, the historical traffic flow analysis showed that within the past 7 days, 53% of all visits to the client website 4000 came from general online ads that landed on the home page (Home step) while 47% of the visits came from targeted online ads. For visitors from the targeted online ads, 21% of them visited TechCoValue.com (the Value Message step) while 26% visited TechCoGadget.com (the Gadget Message Step). Of the 53% home page visitors, 5% of them opted in via the Opt In0 step while 68% of them continued on to the Segment by Navigation step. 31% of those who visited Segment by Navigation step went on to the Value Message step while 37% visited Gadget Message step. From there 34% of those who visited the Value Message step continued to the Coupon step while 7% of them opted in at the Opt In1 a step and exited the client website 4000. The visitors who visited the Coupon step, 31% of them made a purchase at the sale1 step but only 83% of those who made the purchase chose to opt in at the Opt In1 step.

Back to the Gadget Message step, and from there 21% of the visitors went on to the Add-On step while 9% opted in at the Opt In2b step and left the client website 4000. Of those visitors who visited the Add-On step, 75% of them purchased an add-on product at the Sale2 step, in addition to the intended product while 25% purchased only the intended product at the Sale2a step. Of those who purchased the add-on product, 88% of them also opted in at Opt In2 before leaving the website. Of those who only purchased the intended product, 73% opted in at Opt In2a before leaving the website.

Based on the traffic flow information, the user would now be able to make an informed assumption as to the expected increase in traffic volume to Value Message step if he proceeded with the ad campaign. He can enter the likelihood of a traverse between a referral site (targeted online ad) and value message as 40% based on the 21% history data. Outcome of the simulation will then be the Paths with the given assumptions (value path in the above example) and the “new”% traffic flow calculated to each path and each step, with the new scores per individual path and the website 4000 by the simulation engine 3000. In accordance with an exemplary aspect of the claimed invention, the simulation engine 3000 incorporates advanced traffic flow model and optimization techniques to ensure accurate outcome. Further, the simulation engine 3000 incorporates similar algorithm as the segment placement engine 2200 and the segment placement optimizer 2300 to self improve forecasting, and incorporates data pattern recognized within the iPath's collective knowledge store to ensure forecasting accuracy.

In accordance with an exemplary embodiment of the claimed invention, the iPath system 1000 comprises an iPath ETL (extract, transform and load) utility 1400 which allows mapping of data to and from the iPath database format. The iPath ETL utility 1400 enables the iPath user to import web-server logs that can be used for scoring iPaths for specific client websites 4000. The ETL utility 1400 converts web-server logs into an acceptable format for the iPath database 5000. The ETL utility 1400 also provides the ability to export data to a client business intelligence (BI), data warehouse and reporting platform. It is appreciated that the ETL utility 1400 will be used primarily by the system administrator with input from the client IT support where client network, security or other access information is required.

The iPath ETL utility 1400 comprise facilities to translate log files from all major web server platforms including Apache, WebLogic, and IIS, and translate from the standard formats (e.g. W3C). The iPath ETL utility 1400 integrates existing software that will be flexible enough to handle standard web server logs and recognize the intelligent tags inserted by the iPath website interface 1200.

In accordance with an exemplary embodiment of the claimed invention, the iPath ETL utility 1400 comprises a manage import templates component 1410, a connect to web server component 1420, an import web-server log component 1430, a manage export templates component 1440, and a connect to client report platform component 1450. The manage import templates component 1410 enables the user, preferably client administrator, to add, modify and/or remove templates for mapping fields in the client website logs to fields in iPath database 5000. For example, the client or system administrator can individually map a client's web-server log file format to the iPath Database layout and save the information as a template using the manage import templates component 1410. The user can invoke the connect to web server component 1420 to establish connection between the iPath ETL utility 1400 and server hosting the client website logs, and then invoke the import web-server log component 1430 to download the client website log to the iPath system 1000. The user can invoke the manage export templates component 1440 to create export templates for client BI and reporting platform, and then export the generated template to the client BI and reporting platform by invoking the connect to client report platform 1450 to establish connection with the client reporting platform. That is, the system or client administrator can map the iPath database layout to the client BI and reporting platform and save the information as a template using the manage export templates component 1440.

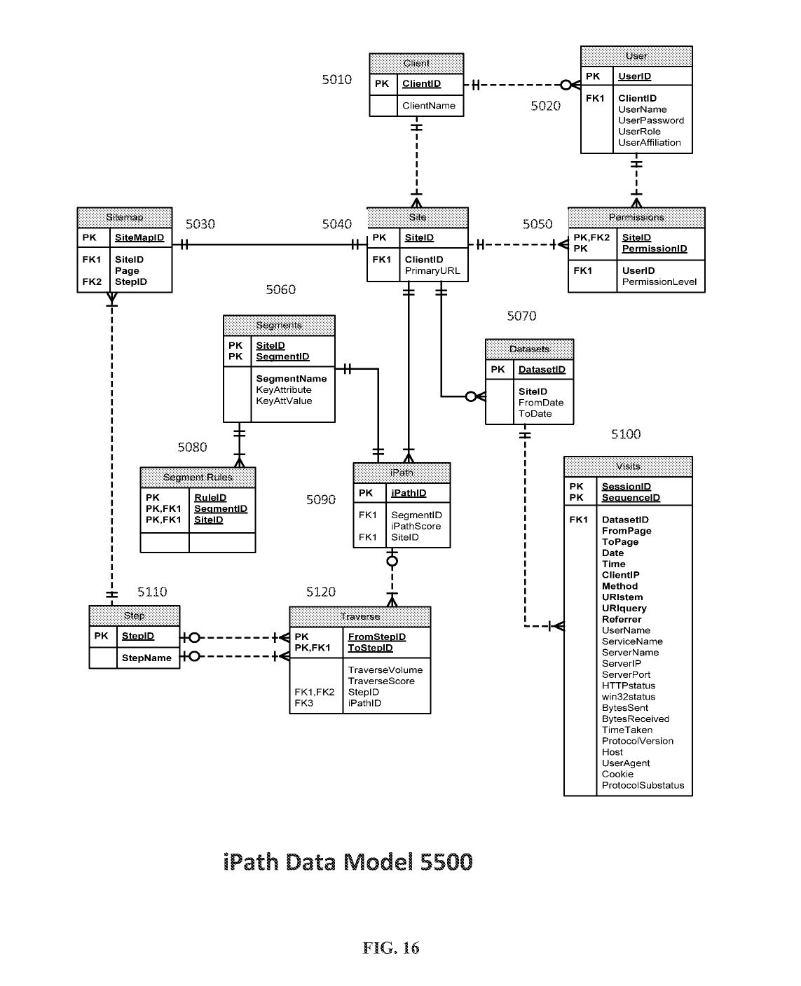

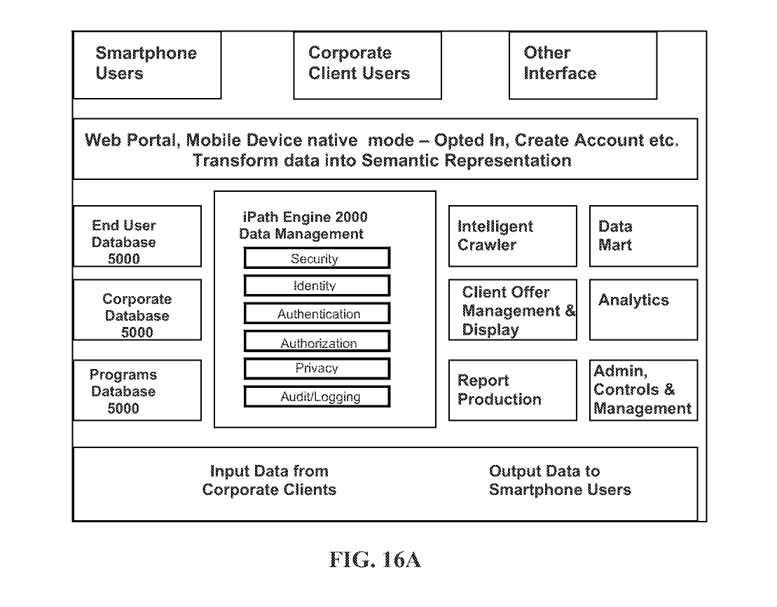

Turning now to FIG. 16, in accordance with an exemplary embodiment of the claimed invention, there is illustrated an exemplary iPath data model 5500 of the iPath database structure to support the iPath metadata and datasets. Preferably, the database 5000 is configurable for clients and extendible to multiple industry standards for web server log formats and intelligent tagging. The various exemplary entities shown in FIG. 16 will now be described herein. The client entity 5010 identifies the owner or operator of the client website 4000. The user entity 5020 is an employee, consultant or agent of the client. The sitemap entity 5030 is the “physical” map of the client website 4000 presented as a hierarchical listing of the web pages. The site entity 5040 is the unique URL (uniform resource locator) associated with a brand or product to be measured by the iPath system 1000. The permissions entity 5050 is a user's permission which defines her access to various components of the iPath system 1000 and the client website 4000. The segment entity 5060 is defined by a set of business rules that are processed in priority order to assign a visitor to an iPath. The datasets entity 5070 identifies a range of data. The segment rules entity 5080 is a rule for segment assignment. The iPath entity 5090 is a sequence of steps or customer interactions. The visits entity 5100 is an instance of a path, i.e., a customer's interactions with the client website 4000 or a session. The step entity 5110 is an interaction of the customer with the client website 4000, e.g., an access or visit to a web page. The traverse entity 5120 is the movement from one step to another for an iPath.

Turning to FIG. 16a, in accordance with an exemplary embodiment of the claimed invention, there is illustrated an exemplary iPath simplified application architecture to support the development of the iPath system 1000. Clients can access iPath system 1000 through a communications network 200 via the client/customer mobile devices 100 such as smartphones, tablets, laptops, connected client/customer devices 100 such as desktops, or other interface(s). The interface to iPath system 1000 can be through a web portal or a native mobile application for the mobile iPath function of iPath system 1000. The iPath system 1000 process data into three separate categories: end user, corporate, and program data, and store these data in the database 5000. Data will be managed according to rules set in iPath engine 2000 such as authentication, authorization, etc. The iPath engine 2000 also performs intelligent crawling of the Internet and manage client sales offers such as coupons and other sales information for the mobile iPath component. The iPath engine 2000 has an interface to analytics software/tools and reporting capability, as well as management functions such as administration and system control. The iPath system 1000 can receive sales and other offer information from the client systems through the communications network 200, and wireless transmit data to the mobile devices 100, e.g., smart phones through the same communications network 200.

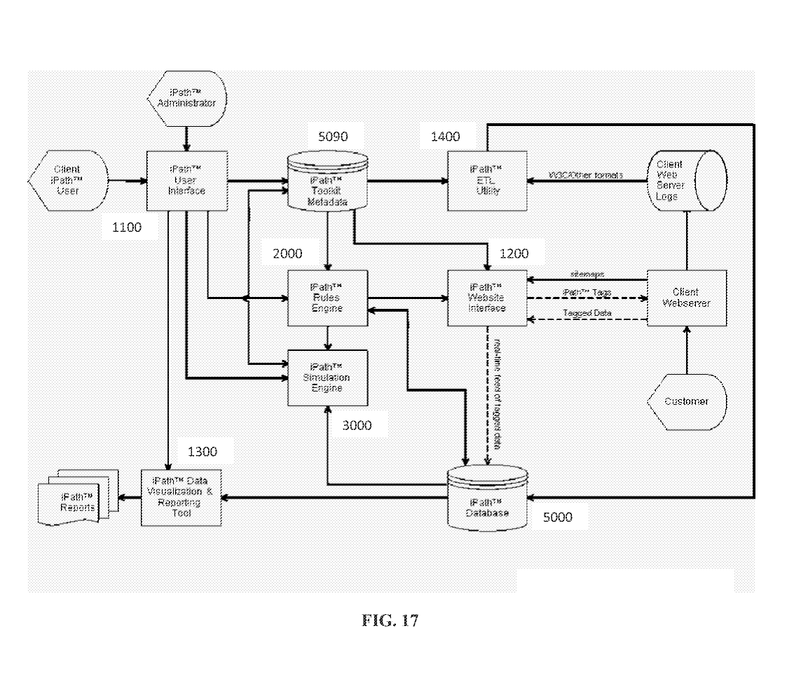

Turning now to FIG. 17, there is illustrated an exemplary data flow diagram representing the flow of data between components and databases 5000. The real-time feed from the website interface 1200, and the set up and receipt of iPath tags by the website interface 1200. The iPath user interface 1100 stores user input in the iPath toolkit metadata 5090 and invokes iPath rules engine 2000 to drill down a path adherence, calculate an iPath score or perform other functions. Alternatively, the iPath user interface can invoke the iPath simulation engine 3000 to simulate a desire change to the client website 4000. iPath toolkit metadata 5090 also communicates with iPath website interface to ensure proper information (i.e. session id, last page visited) is received from client webserver, and iPath ETL utility to ensure necessary information is received by the client web server logs and transformed into the desired data format. iPath database 5000 provides all the data necessary for iPath rules engine 2000 and iPath simulation engine 3000 to perform their respective functions, while providing data to iPath data visualization & reporting tool 1300 for dashboard display of different reports. Finally iPath user interface 1100 invokes iPath data visualization & reporting tool 1300 for users to view the desired reports.

Generally, in accordance with an exemplary embodiment of the claimed invention, the inventive system can be provided as a software program that is part of a client-server web-based application or application as a service such as a website that a user can access through the Internet by having an account with the website. The client portion of software program can be downloaded from a website or stored on a tangible recordable medium, such as a disk, CD, DVD, flash memory or portable storage device and the like, or stored in the cloud based on the cloud computing architecture.

Although the description includes exemplary embodiments, it can be easily seen that other embodiments are possible, and changes can be made to the embodiments described without departing from the spirit of the disclosed system and method.

In accordance with an exemplary embodiment of the claimed invention, a user communicates with a computing environment, which can comprise a processor based Web Server or multiple server computers in a client/server relationship or a cloud based relationship on a communications network, such as the Internet. In a client/server environment, the processor based Web Server comprises a web application that communicates with a network enabled user devices, which may be a personal computer (PC), a laptop, a tablet, a hand-held electronic device (such as a PDA), a mobile or cellular wireless phone, a TV set, or any other web-enabled electronic device as would be understood by those of skill in the art.

The inventive system can utilize any type of electronic transmission medium, for example, including but not limited to the following networks: a virtual private network, a public Internet, a private Internet, a secure Internet, a private network, a public network, a value-added network, an intranet, a mesh network, a wireless gateway or the like. The term “virtual private network” refers to a secure and encrypted communications link between nodes on the system, a Wide Area Network (WAN), Intranet, the Internet or any other network transmission means. In addition, the connectivity to the Internet may be via, for example, Ethernet, Token Ring, Fiber Distributed Datalink Interface, Asynchronous Transfer Mode, Wireless Application Protocol, or any other form of network connectivity. A user device may connect to the system by use of a modem or by use of a network interface card that resides in a user device.

1. A computer implemented method for quantitatively measuring effectiveness of a marketing campaign or marketing strategy execution, comprising the steps of:
accessing a processor based server over a communications network to define targeted customer segments based on the marketing campaign or a specific set of marketing objectives by a client using a client device;
defining a quantifiable outcome or payoff for each targeted customer segment of the client on the server by invoking one or more component tools of the server by the client device over the communications network, thereby linking the performance of client's marketing campaign or objectives to said quantifiable outcome for each targeted customer segment;
generating behavior paths for each targeted customer segment on a client website using the server for effective measurement of adherence of a website visitor/customer to the behavior paths associated with said visitor/customer's targeted customer segment leading to said quantifiable outcome;
assigning a weight to each step of each behavior path for each targeted customer segment by the client using said one or more component tools of the server;
categorizing the customer visiting the client website into one of said targeted customer segments by a rules engine of the server based on segmentation rules;
determining a customer path traversed on the client website;
calculating a path score by the rules engine of the server in accordance with rules associated with the targeted customer segments established by the client and the weight assigned to each step of the customer path to determine whether the customer adheres to or diverges from a preferred behavior path established for the customer's targeted customer segment; and
storing the path score and the customer path in a database.

2. The method of claim 1, further comprising the step of analyzing the client website to import sitemaps and to imbed tags to various pages of the client website to facilitate data collection and analysis by the server.

3. The method of claim 1, further comprising the step of determining whether the customer was correctly placed into the targeted customer segment based on the segmentation rules established by the client and imposed by the rules engine of the server.

4. The method of claim 3, further comprising the step of categorizing the customer by the rules engine based on at least the following segmentation rules: a first webpage of the client website accessed by the customer or a landing page rule and a website visited by the customer before accessing the client website or a referral website rule.

5. The method of claim 4, wherein the rules engine is a self-learning rules engine and further comprising the step of adding, deleting or modifying the segmentation rules to correctly place misplaced customers into a correct targeted customer segment in the future by the self-learning rules engine of the server; and storing the added or modified segmentation rules in the database.

6. The method of claim 4, further comprising the step of assigning a priority rank to each segmentation rule to prioritize the segmentation rules.

7. The method of claim 1, further comprising the step of filtering web data to exclude immaterial visits to client website.

8. The method of claim 1, further comprising the step of generating the preferred behavior path for each targeted customer segment to shape customer interactions on the client website and guide the customer to the preferred behavior path, thereby maximizing said quantifiable outcome consistent with the client's marketing campaign or objectives.

9. The method of claim 1, further comprising the step of simulating changes to the client websites by a simulation engine of the server to determine its effectiveness before actually deploying the changes to the client website.

10. The method of claim 1, further comprising the step of generating a standard or custom data visualization report based on a data range selected by the user.

11. A system for quantitatively measuring effectiveness of a marketing campaign or marketing strategy execution, comprising:
a processor based server comprising rules engine and one or more component tools;
a client device accessing the server over a communications network to define targeted customer segments based on the marketing campaign or a specific set of marketing objectives; to define a quantifiable outcome or payoff for each targeted customer segment of the client on the server by invoking one or more component tools of the server, thereby linking the performance of client's marketing campaign or objectives to said quantifiable outcome for each targeted customer segment; and
wherein the server generates behavior paths for each targeted customer segment on a client website for effective measurement of adherence of a website visitor/customer to the behavior paths associated with the visitor/customer's targeted customer segment leading to said quantifiable outcome; and assigns a weight to each step of each behavior path for each targeted customer segment based on a client input from said one or more component tools accessed by the client device over said communications network;
wherein the rules engine categorizes the visitor/customer visiting the client website into one of said targeted customer segments based on segmentation rules; determines a customer path traversed on the client website; and calculates a path score in accordance with rules associated with the targeted customer segment established by the client and the weight assigned to each step of the customer path to determine whether the customer adheres to or diverges from a preferred behavior path established for the customer's targeted customer segment; and
a database for storing the path score and the customer path.

12. The system of claim 11, wherein said one or more component tools of the server analyzes the client website to import sitemaps and imbed tags to various pages of the client website to facilitate data collection and analysis by the server.

13. The system of claim 11, wherein the rules engine of the server determines whether the customer was correctly placed into the targeted customer segment based on the segmentation rules established by the client.

14. The system of claim 13, wherein the rules engine categorizes the customer based on at least one of the following segmentation rules: a first webpage of the client website accessed by the customer or a landing page rule and a website visited by the customer before accessing the client website or a referral website rule.

15. The system of claim 14, wherein the rules engine is a self-learning rules engine, and adds, deletes and modifies the segmentation rules to correctly place misplaced customers into a correct targeted customer segment in the future; and stores the added or modified segmentation rules in the database.

16. The system of claim 14, wherein the segmentation rules are ranked or prioritized based on a client input and wherein the rules engine favors the segmentation rules with a higher rank or priority.

18. The system of claim 11, wherein the server generates the preferred behavior path for each targeted customer segment to shape customer interactions on the client website and guides the customer to the preferred behavior path, thereby maximizing said quantifiable outcome consistent with the client's marketing campaign or objectives.

19. The system of claim 11, wherein the server further comprises a simulation engine to simulate changes to the client websites to determine its effectiveness before actually deploying the changes to the client website.

20. A non-transitory computer readable medium comprising computer executable code for quantitatively measuring effectiveness of a marketing campaign or marketing strategy execution, said computer executable code comprising instructions:
accessing a processor based server over a communications network to define targeted customer segments based on the marketing campaign or a specific set of marketing objectives by a client using a client device;
defining a quantifiable outcome or payoff for each targeted customer segment of the client on the server by invoking one or more component tools of the server by the client device over the communications network, thereby linking the performance of client's marketing campaign or objectives to said quantifiable outcome for each targeted customer segment;
generating behavior paths for each targeted customer segment on a client website using the server for effective measurement of adherence of a website visitor/customer to the behavior paths associated with said visitor/customer's targeted customer segment leading to said quantifiable outcome;
assigning a weight to each step of each behavior path for each targeted customer segment by the client using said one or more component tools of the server;
categorizing the customer visiting the client website into one of said targeted customer segments by a rules engine of the server based on segmentation rules;
determining a customer path traversed on the client website;
calculating a path score by the rules engine of the server in accordance with rules associated with the targeted customer segments established by the client and the weight assigned to each step of the customer path to determine whether the customer adheres to or diverges from a preferred behavior path established for the customer's targeted customer segment; and
storing the path score and the customer path in a database.
